(19) United States
(12) Patent Application Publication
(10) Pub. No.: US 2016/0209973 A1
(43) Pub. Date: Jul. 21, 2016

(54) APPLICATION USER INTERFACE RECONFIGURATION BASED ON AN EXPERIENCE MODE TRANSITION

(71) Applicant: Microsoft Technology Licensing, LLC., Redmond, WA (US)

(72) Inventors: Jonathan S. Kaufthal, Seattle, WA (US); Charles Scott Walker, Sammamish, WA (US)

(73) Assignee: Microsoft Technology Licensing, LLC., Redmond, WA (US)

(21) Appl. No.: 14/755,438

(22) Filed: Jun. 30, 2015

Related U.S. Application Data
(60) Provisional application No. 62/105,774, filed on Jan. 21, 2015.

(51) Int. Cl. G06F 3/041

(52) U.S. Cl. CPC G06F 3/0416

(57) ABSTRACT

Aspects of a system and method for transitioning a configuration of a user interface (UI) of an application to a particular experience mode configuration in response to a transition of experience modes by an operating system (OS) is described. The application UI may be transitioned from a configuration optimized for hardware input interaction to a configuration optimized for interaction via natural input methods, or vice versa. An experience mode transition triggering event is detected by the OS, and in response, the OS transitions from a first experience mode to a second experience mode, and communicates the transition to the application. In response to the communication, the application transitions to the second experience mode, and reconfigures the UI to a configuration associated with the second experience mode. Other aspects enable a user to manually switch experience modes via the application, and remain in the selected mode when the OS transitions modes.

### CROSS-REFERENCE TO RELATED APPLICATIONS

This application claims the benefit of U.S. Provisional Patent Application No. 62/105,774, titled “Application User Interface Reconfiguration Based on an Experience Mode Transition” filed Jan. 21, 2015.

### BACKGROUND

Modern day users use software applications to perform various tasks that may be executed on various types of computing devices (e.g., tablets, smartphones, laptops, desktops computers, convertible computers, etc.). A variety of computing devices support more than one mode of input, such as, touch input, mouse input, pen/stylus input, gesture input, etc., and thus support interaction in a variety of usage scenarios. To assist users to locate and utilize functionalities of a given application, a user interface containing a plurality of selectable functionality controls is provided. An arrangement of the functionality controls provides for a better user experience depending on particular usage scenario. For example, in a desktop experience mode, where entry may be more precise, a user interface may comprise more options with smaller hit targets. On the contrary, in a natural input experience mode, a user interface allowing for less precise entry, such as a user interface with larger spacing between functionality controls for providing enough space for a user's finger to access options, may be more optimal.

### BRIEF SUMMARY

This summary is provided to introduce a selection of concepts in a simplified form that are further described below in the Detailed Description section. This summary is not intended to identify key features or essential features of the claimed subject matter, nor is it intended to be used to limit the scope of the claimed subject matter.

Aspects of a system provide for transitioning an application user interface to a particular experience mode configuration based on a detection of an experience mode transition triggering event signaled by an operating system or by the application. According to various aspects, transitioning an application user interface to a particular experience mode configuration discussed herein enables applications to operate in both a desktop experience mode and a natural input experience mode without requiring a user to manually switch experience modes. Further, aspects enable switching between a desktop experience mode and a natural input experience mode without interrupting operational continuity and interaction context of the operating system or the application.

Examples are implemented as a computer process, a computing system, or as an article of manufacture such as a computer program product or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 is a block diagram illustrating a system for transitioning a user interface of an application to a particular experience mode configuration in response to an experience mode transition triggering event;

FIG. 2A is a high level flowchart showing general stages involved in an example method for transitioning an application user interface to a particular experience mode configuration in response to an experience mode transition triggering event signaled by the operating system;

FIG. 2B is a high level flowchart showing general stages involved in another example method for transitioning an application user interface to a particular experience mode configuration in response to an experience mode transition triggering event signaled by the operating system;

FIG. 2C is a high level flowchart showing general stages involved in an example method for transitioning an application user interface to a particular experience mode configuration in response to an experience mode transition triggering event signaled by the application;

FIG. 2D is a high level flowchart showing general stages involved in an example method for transitioning to a mode-optimized version of an application in response based on a detection of an experience mode transition triggering event signaled by the operating system;

FIG. 3 is an illustration of an example computing device attached to a hardware input device;

FIG. 4 is an illustration of a user selecting to launch an application in a desktop experience mode start menu displayed on the computing device;

FIG. 5 is an illustration of an application displayed on the computing device and including a display of an application desktop experience mode UI;

FIG. 6 is an illustration of an example of a mode transition event generated by a user disconnecting a hardware input device from a computing device and a notification for receiving user permission for transitioning to the desktop experience mode;

FIG. 7 is an illustration the application transitioning to the natural input experience mode and reconfiguring the application UI to a natural input experience mode UI;

FIG. 8 is an illustration of a user selecting to launch an application from a natural input experience mode start menu;

FIG. 9 is an illustration of an application UI displayed as a natural input experience mode UI on the display of the computing device;

FIG. 10 is an illustration of a natural input floating contextual UI menu;

FIG. 11 is an illustration of functionality controls in the natural input experience application UI menu;

FIG. 12 is an illustration of functionalities such as callouts and dropdown menus in the natural input experience application UI menu;

FIG. 13 is an illustration of an example of a mode transition event generated by a user connecting a hardware input device to a computing device;

FIG. 14 is an illustration of a notification displayed on the computing device prompting the user to select to transition from the natural input experience mode to a desktop experience mode;

FIG. 15 is an illustration of the application UI reconfigured to a desktop experience mode UI;

FIG. 16 is an illustration of a desktop experience application UI menu displayed in the desktop experience mode UI;

FIG. 17 is an illustration of an desktop experience mode UI;

FIG. 18A is an illustration of an example application UI displayed in the natural input experience mode and including a touch action bar;

FIG. 18B shows a comparison of an example desktop experience mode application UI menu and an example natural input experience mode application UI menu;

FIG. 19 is a block diagram illustrating one example of the physical components of a computing device with which examples may be practiced;

FIG. 20A and 20B are simplified block diagrams of a mobile computing device with which examples may be practiced; and

FIG. 21 is a simplified block diagram of a distributed computing system in which examples may be practiced.

### DETAILED DESCRIPTION

Various aspects are described more fully below with reference to the accompanying drawings, which form a part hereof, and which show specific exemplary aspects. However, aspects may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Aspects of a system for transitioning an user interface of an application to a particular experience mode configuration based on a detection of an experience mode transition triggering event signaled by the application or by the operating system are described herein and illustrated in the accompanying figures. Aspects enable transitioning the user interface of the application and the operating system to a particular experience mode configuration that is tailored to a usage scenario according to the detected experience mode transition triggering event, and thus optimize the user's interaction with the device. Generally, enabling transitioning of a user interface of the application and the operating system to a particular experience mode configuration that is tailored to a usage scenario increases user and computational efficiency and decreases an amount of time it takes to complete various tasks. According to an aspect, techniques discussed herein detect a triggering event and transition the application user interface and the operating system user interface experience mode configuration upon receiving a positive response from a user. According to another aspect, techniques discussed herein detect a triggering event and transition the application user interface and the operating system user interface experience mode configuration without requiring a user to provide a separate action to cause the transition.

Aspects reduce user interaction time and user inconvenience since a user need not manually transition between user interface experience modes or rediscover and/or restore a context when a switch between experience modes occurs in the application or in the operating system. Further, a number of required user interactions with a computing device is reduced since a user may continue interacting with an application across a switch between experience modes, thus increasing computational efficiency and decreasing an amount of time it takes to complete various tasks. Further, computing resources are conserved by reducing a number of inputs that must be processed to perform tasks such as switching between different experience modes of the operating system and the application.

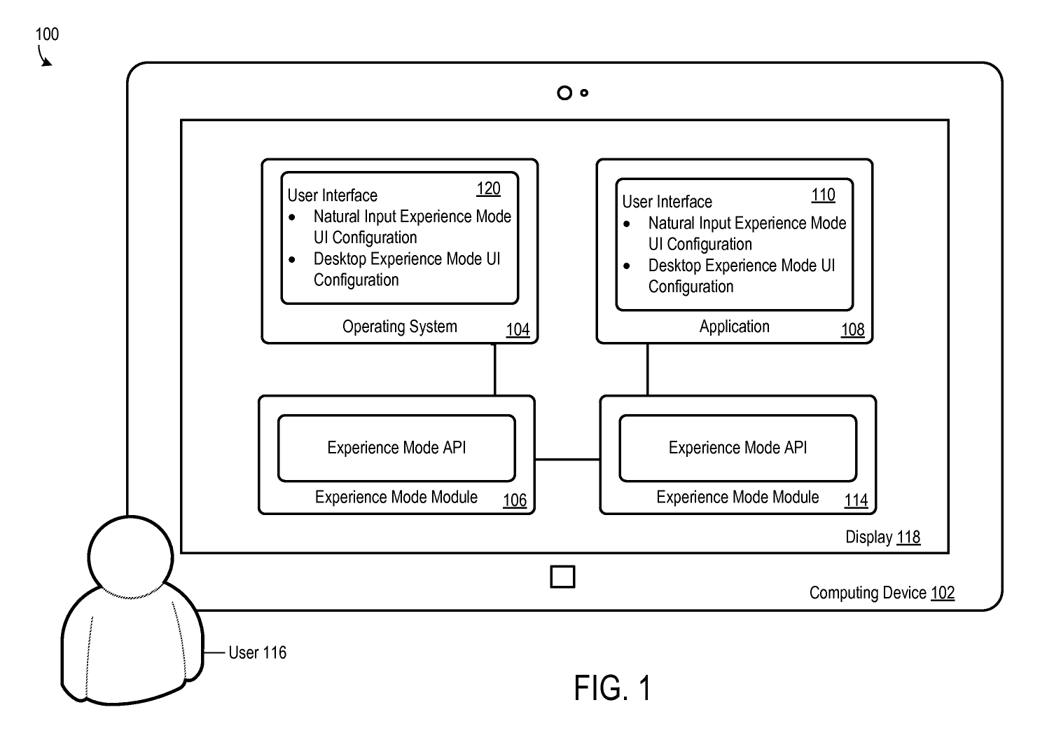

FIG. 1 is a block diagram illustrating a system for transitioning a user interface experience mode configuration of an application based on a detection of an experience mode transition triggering event signaled by the application or the operating system (sometimes referred to herein as OS). The system 100 includes an operating system 104 having one or more operating system user interfaces 120, an operating system experience mode module 106, and at least one application 108 having one or more application user interfaces 110 (application UI(s) 110). A user 116 utilizes an application 108 on the computing device 102 for a variety of tasks, for example, to write, calculate, draw, organize, prepare presentations, send and receive electronic mail, take and organize notes, make music, and the like. According to an aspect, applications 108 include thick client applications stored locally on the computing device. According to another aspect, applications 108 include thin client applications (i.e., web applications) that reside on a remote server and are accessible over a network, such as the Internet or an intranet. For example, a thin client application is hosted in a browser-controlled environment or coded in a browser-supported language and reliant on a common web browser to render the application 108 executable on the computing device 102. The computing device 102 is configured to receive content for presentation on a display 118.

The application 108 is configured to enable a user 116 to use a pointing device (e.g., a pen/stylus, mouse, etc.) and/or to utilize sensors (e.g., touch sensor, gesture sensor, hover sensor, accelerometer, gyroscope, tilt sensor, etc.) on the computing device 102 to interact with content via a number of input modes. According to an aspect, the computing device 102 is operable to support more than one mode of input, and thus support interaction in a variety of usage scenarios.

To assist users to locate and utilize functionalities of a given application 108, an application user interface (UI) 110 containing a plurality of selectable functionality controls is provided. An arrangement of the functionality controls provides for a better user experience depending on a particular usage scenario. For example, in a desktop experience mode, where entry may be more precise, an application UI 110 may comprise more functionality controls with smaller hit targets. According to another example, in a natural input experience mode, an arrangement of functionality controls in the application UI allows for less precise entry, for example, by providing larger spacing between functionality controls to allow enough space for a user's finger to access options. The application 108 is in communication with an application UI experience mode module 114, which includes functionality for transitioning the application UI from a natural input experience mode configuration to a desktop experience mode configuration and vice versa. According to an aspect, the application experience mode module 114 is a component of the application 108. In some examples, the application UI experience mode module 114 includes an experience mode application protocol interface (API), which reports experience mode transition triggering events initiated in the application 108 to the operating system 104. For example, an experience mode transition triggering event includes a selection of an experience mode functionality control displayed in the application UI 110.

Referring still to FIG. 1, the system 100 comprises an operating system

(OS) experience mode module 106. According to an aspect, the experience mode module 106 enables the operating system 104 on the computing device 102 to operate in and switch between different user experience modes, such as a natural input experience mode, a desktop experience mode, and so forth. For example, depending on the user experience mode, the operating system 104 reconfigures the OS user interface 120 to an experience mode UI configuration that is optimized for either natural input (when the OS 104 is in a natural input experience mode) or for traditional hardware input (when the OS 104 is in a desktop experience mode). According to another aspect, the operating system experience mode module 106 communicates with the application 108, for example, via an experience mode API, to report experience mode transition triggering events initiated in the operating system 104 to the application 108, which indicates to the application 108 when to operate in and switch between different user experience mode UI configurations (e.g., a natural input experience mode UI configuration, a desktop experience mode UI configuration, and so forth). According to an aspect, the operating system experience mode module 106 is a component of the operating system 104.

According to an aspect, the operating system experience mode module 106 includes an experience mode API. Generally, the experience mode API represents an API that provides an interface to interact with the experience mode module 106. According to an aspect, the application 108 can call the OS experience mode API for notification of transitions between different experience modes. Further, according to an aspect, the OS experience mode module 106 utilizes the OS experience mode API to communicate various experience-related events to the application 108. In some examples, the operating system 104 can call the application experience mode API for notification of transitions between different experience modes. Further, the application experience mode module 114 utilizes the application experience mode API to communicate various experience-related events to the operating system 104.

Generally, a “natural input experience mode” refers to an operational mode in which various visual, functional, and behavioral characteristics of the computing device 102 are optimized for user interaction with the computing device 102 in a “natural” manner, free from artificial constraints imposed by input devices such as mice, keyboards, remote controls, and the like. For example, natural input methods include those relying on touch recognition, gesture recognition both on screen and adjacent to the screen, air gestures, head and eye tracking, etc. In the operating system UI 120, the natural input experience mode UI configuration presents a multi-application environment as an immersive environment that expands system menus, enlarges menu selection items, expands hit target areas for menu selection items, provides a back button in a status bar, etc. In some examples, the natural input experience mode UI configuration excludes usage of desktop-like displays and affordances, such as a status bar (e.g. a taskbar), title bars, and so forth. While the natural input experience mode is described as a collection of individual input experience modes and the natural input experience mode UI configuration is described as a configuration that is generally optimized for user interaction and input in a “natural manner,” it should be appreciated that each individual natural interaction and input method (e.g., those relying on touch recognition, gesture recognition both on screen and adjacent to the screen, air gestures, head and eye tracking, etc.) may have its own separate input experience mode (e.g., a touch mode, a gesture mode, an air gesture mode, a head and eye tracking mode, etc.).

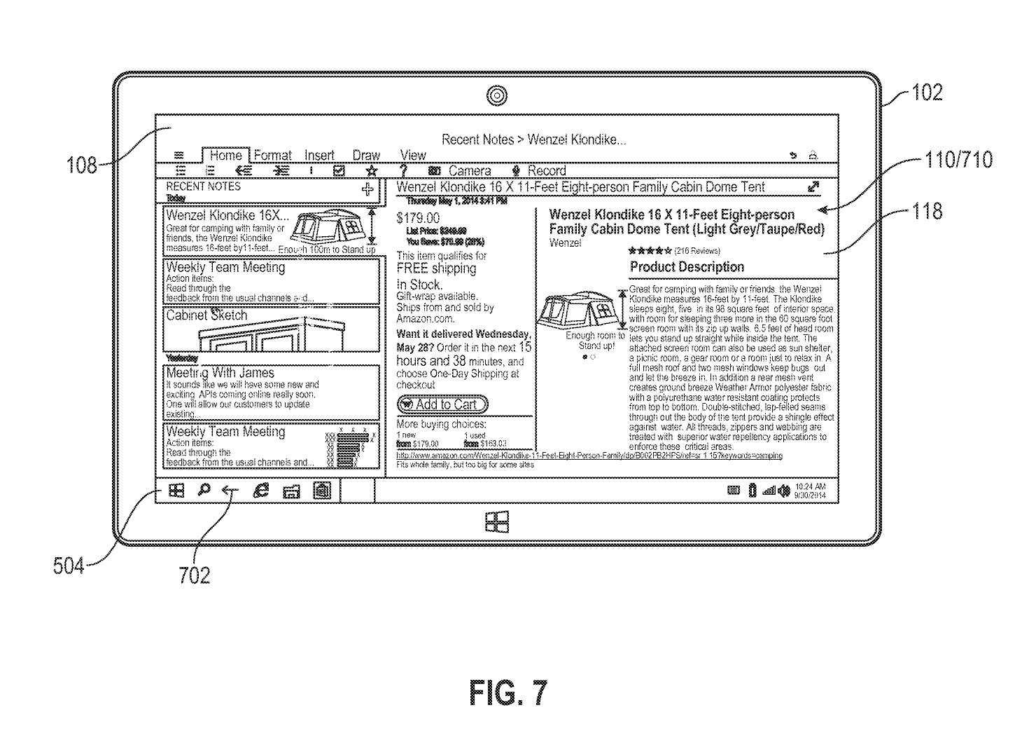

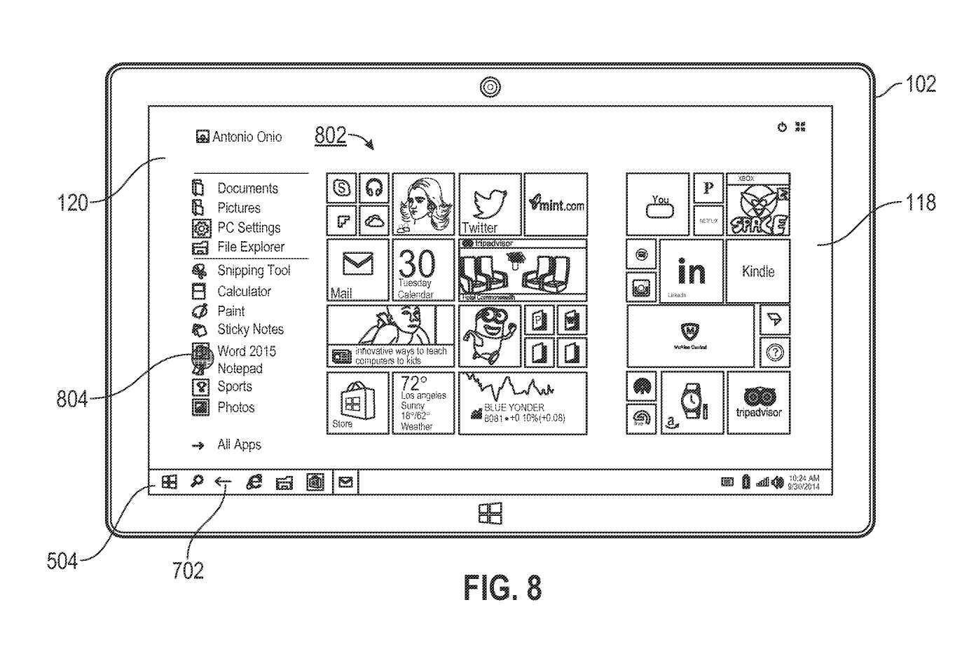

An example operating system UI 120 in the natural input experience mode UI configuration is illustrated in FIG. 8. In the application UI 110, the natural input experience mode UI configuration provides extra spacing functionality controls, enlarges functionality controls, expands hit target areas for functionality controls, and changes the behavior of functionality controls in a manner that is optimized for touch input, gesture input, air gestures input, head and eye tracking input, etc., for example, conversion of standard buttons to split buttons with dropdowns, providing callouts, removing spinner controls, removing application UI window controls (e.g., minimize, maximize, close, and restore commands), providing a touch action bar pinned along a side of the display 118, and providing floating contextual user interface menus. According to an aspect, when transitioning from the desktop experience mode to the natural input experience mode, the application UI experience mode module 114 disables particular application UI interaction functionalities (e.g., hovering). Example application UIs 110 in the natural input experience mode UI configuration are illustrated in FIGS. 7 and 9-14.

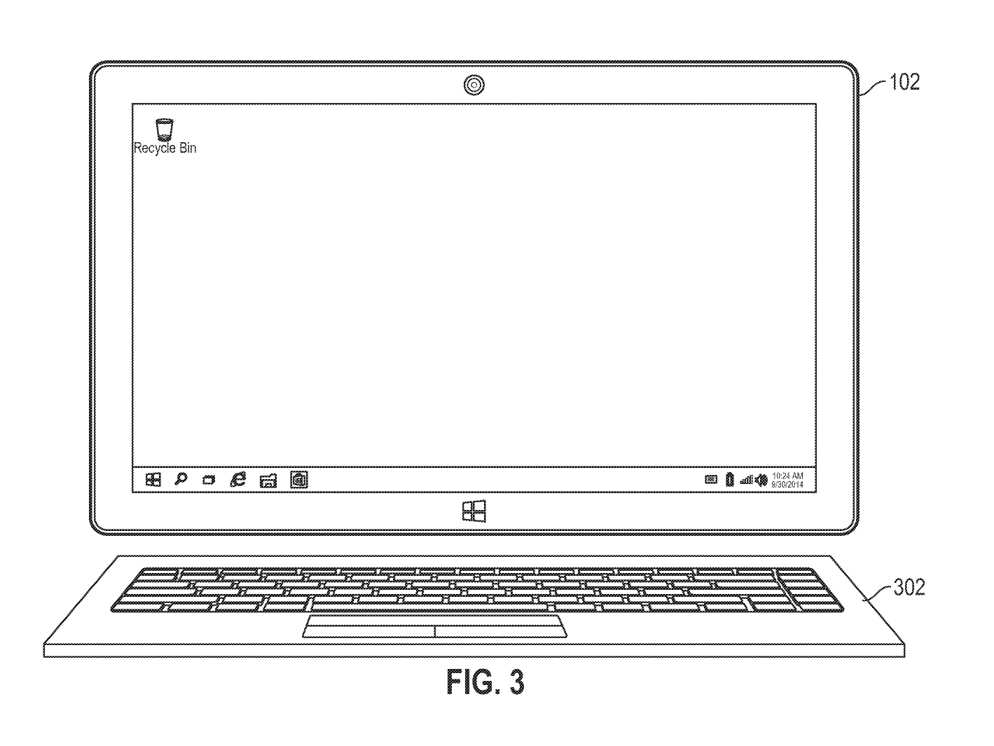

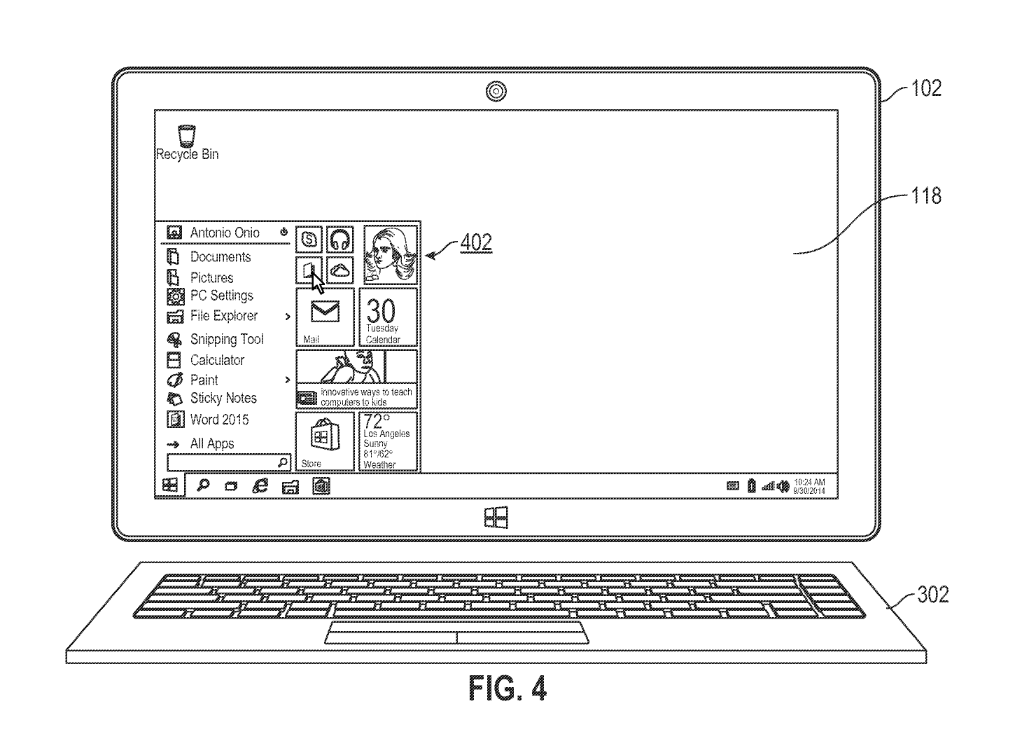

A “desktop experience mode” generally refers to a more traditional operational mode, such as involving user interaction via a mouse, trackpad, hardware keyboard, and so forth. In the operating system UI 120, the desktop experience mode UI configuration presents a multi-application environment as a multi-windowed environment that provides a more compact system menu with smaller menu selection items, decreased hit target areas for menu selection items, etc. In some examples, in the operating system UI 120, the desktop experience mode UI configuration includes usage of desktop-like displays and affordances, such as a status bar (e.g. a taskbar), title bars, and so forth. Example operating system UIs 120 in the desktop experience mode UI configuration are illustrated in FIGS. 3 and 4.

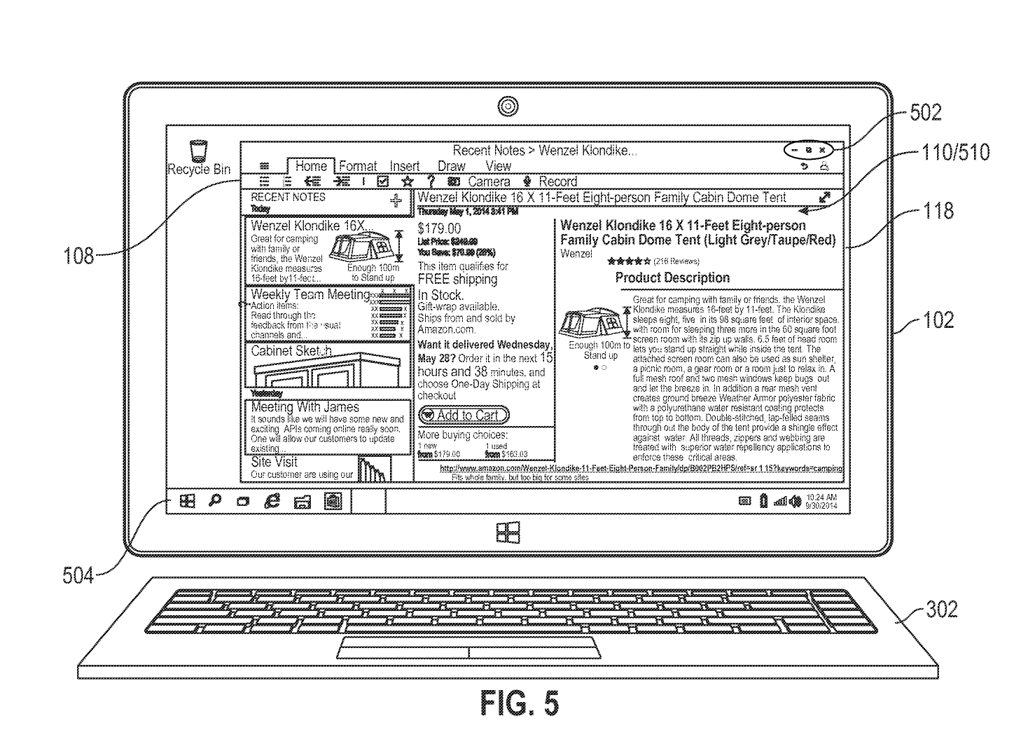

In the application UI 110, the desktop experience mode UI configuration provides more functionality command options with smaller hit targets, and changes the behavior of functionality controls in a manner that is optimized for more precise input methods. Examples application UIs 110 in the desktop experience mode UI configuration are illustrated in FIGS. 5, 6, and 15-17. As further detailed below, the natural input experience mode UI configuration and desktop experience mode UI configuration include different respective visual, functional, and behavioral characteristics that can be applied depending on which mode is active on the computing device 102.

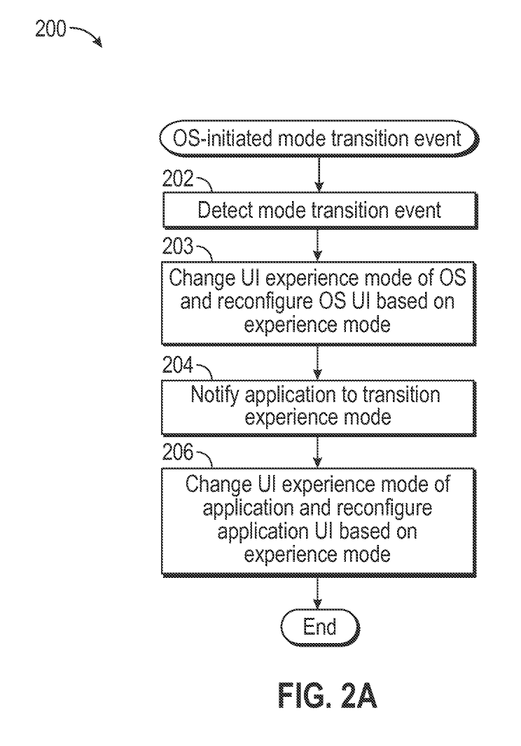

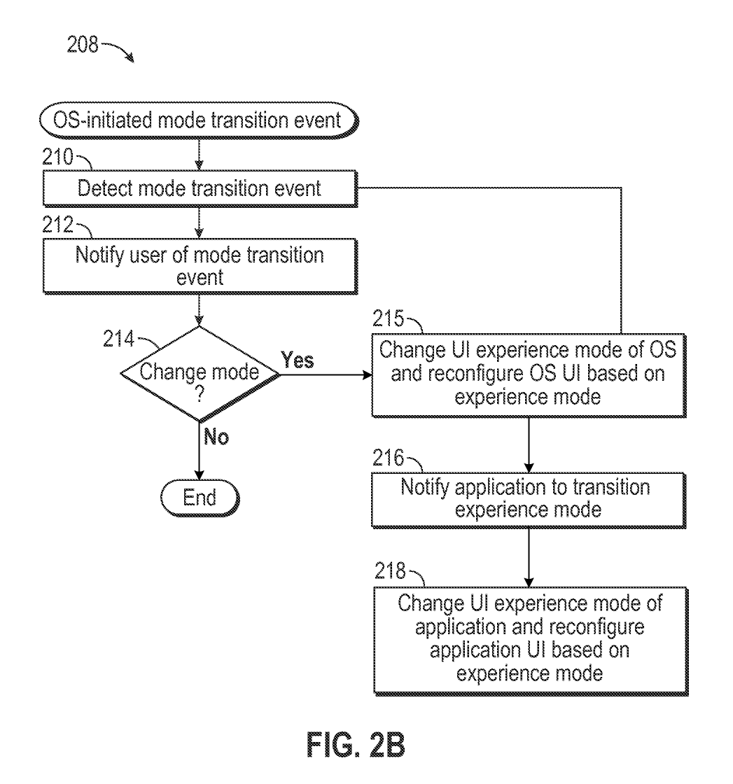

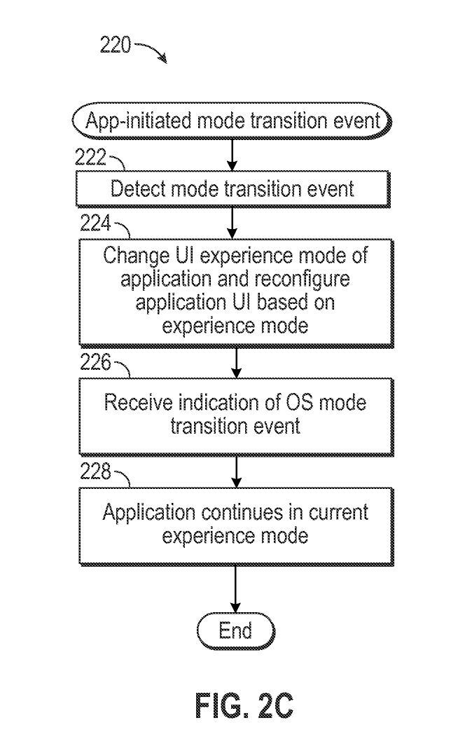

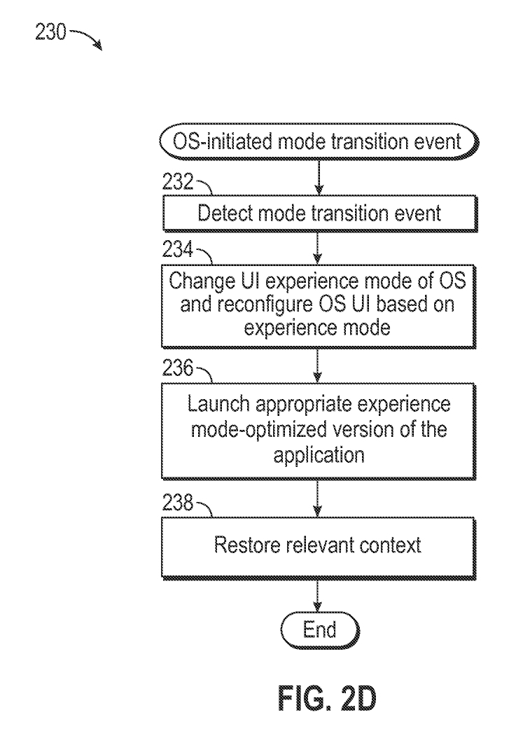

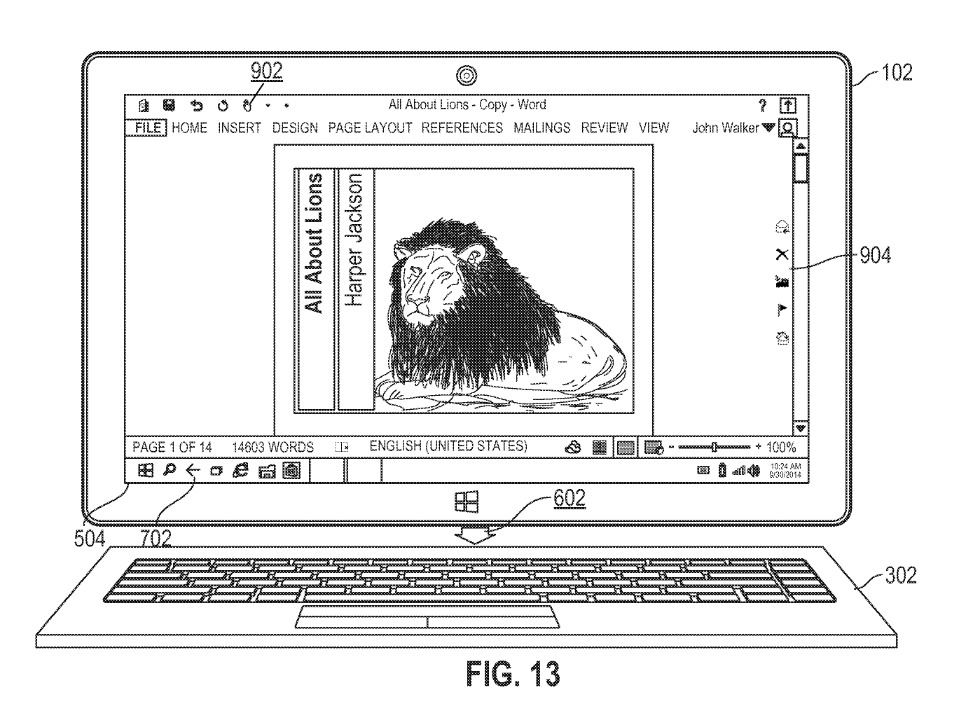

FIG. 2A is a high level flowchart showing general stages involved in an example method for transitioning an application user interface 110 to a particular experience mode configuration based on a detection of an experience mode transition triggering event signaled by the operating system 104. The method 200 begins when an event that indicates a change in experience mode occurs. For instance, the mode transition event represents a change from the desktop experience mode to the natural input experience mode, or vice-versa. A mode transition event may be generated in various ways. According to an aspect, a mode transition event occurs in response to a hardware-based action. For example, a user 116 may connect a hardware input device such as a keyboard and/or a mouse to a portable computing device 102, e.g., a tablet. Such connection may occur in various ways, such as via a physical connection, a wireless connection, and so forth. Connecting the hardware input device to the portable computing device 102 generates a mode transition event. For example, the mode transition event is a call to change from a natural input experience mode to a desktop experience mode. An example of a mode transition event generated by a user 116 connecting a hardware input device to a computing device 102 is illustrated in FIG. 13.

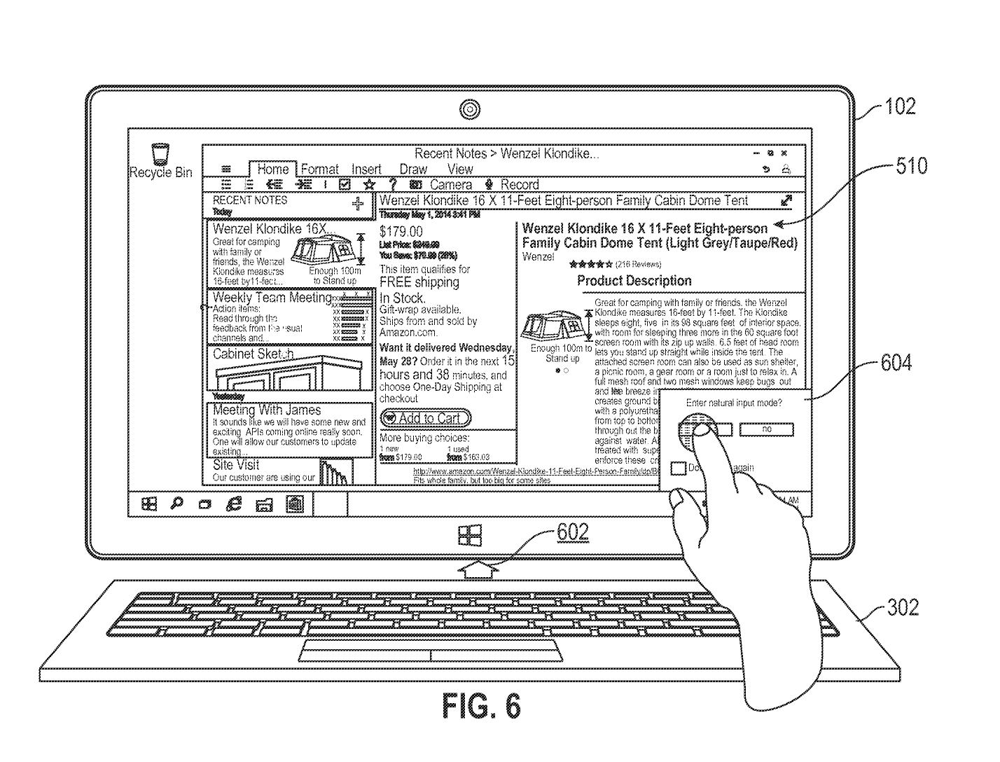

As another example, a user 116 may disconnect a hardware input device from a portable computing device 102. The user 116, for instance, may disconnect a physical connection between the hardware input device and the portable computing device 102. As another example, the user 116 may disable a wireless connection (e.g., a Bluetooth® or other short-range radio technology connection) between the hardware input device and the portable computing device 102. Disconnecting the hardware input device from the portable computing device 102 generates a mode transition event. For example, the mode transition event is a call to change from the desktop experience mode to the natural input experience mode. An example of a mode transition event generated by a user 116 disconnecting a hardware input device from a computing device 102 is illustrated in FIG. 6.

In other examples, a mode transition event is generated in response to user input instructing a change between experience modes. For instance, a selectable mode control may be displayed in the operating system UI 120, which when selected, generates a mode transition event. The selectable mode control may be displayed and/or accessible at various locations in the operating system UI 120, such as in a task bar, a start menu, an options menu, etc. In other examples, the user input instructing a change between experience modes is made via a keyboard, for example, selection of a mode control button on the keyboard or selection of shortcut keys, access keys, etc.

At OPERATION 202, the mode transition event is detected. According to an aspect, the mode transition event is detected by the operating system 104. According to another aspect, the mode transition event is detected by the OS experience mode module 106. In some examples, the mode transition event is detected in response to a notification of a mode change. At OPERATION 203, the OS user interface 120 is transitioned from its current experience mode to the experience mode associated with the mode transition event, and the operating system 104 reconfigures the OS user interface 120 based on the experience mode, for example, from the desktop experience mode configuration to the natural input experience mode configuration or from the natural input experience mode configuration to the desktop experience mode configuration. For example, when reconfiguring the OS user interface 120 to the natural input experience mode configuration, the reconfiguration may include one or more of: providing a back button in a task bar, expanding a display of the application UI 110 to fill a maximal area of the display 118, providing a larger system menu with larger menu selections and extra spacing between menu selection controls, expanding hit target areas for menu selection controls, etc.

The method 200 advances to OPERATION 204, where the application UI experience mode module 114 receives a notification of the mode transition event. For example, the application UI experience mode module 114 makes an API call to the OS experience mode API for querying the experience mode module 106 for an experience mode status. As another example, the application UI experience mode module 114 listens for an event that indicates that the mode transition event has occurred.

The method 200 proceeds to OPERATION 206, where the application 108 reconfigures the application UI 110 based on the experience mode. In one example, a notification is provided to the user prior to the reconfiguration, informing the user that the application UI 110 will be reconfiguring from the desktop experience mode to the natural input experience mode or vice versa. In another example, a notification is provided to the user after the reconfiguration, informing the user of the transition. In yet another example, no notification is provided to the user. According to an aspect, when transitioning from the desktop experience mode to the natural input experience mode, the application UI experience mode module 114 reconfigures the application UI 110 to be optimized for natural interaction input, such as touch input, gesture input, air gestures input, head and eye tracking input, etc. According to an aspect, when transitioning from the desktop experience mode to the natural input experience mode, the application 108 reconfigures the application UI 110, the reconfiguration including at least one of: providing extra spacing functionality controls, enlarging functionality controls, expanding hit target areas for functionality controls, changing the behavior of functionality controls in a manner that is optimized for touch input, gesture input, air gestures input, head and eye tracking input, etc., for example, conversion of standard buttons to split buttons with dropdowns, providing callouts, removing spinner controls, removing application UI window controls (e.g., minimize, maximize, close, and restore commands), providing a touch action bar pinned to a side of the display 118, and providing floating contextual user interface menus. According to an aspect, when transitioning from the desktop experience mode to the natural input experience mode, the application 108 disables particular application UI interaction functionalities (e.g., hovering). Various examples of natural input experience mode UI configurations are illustrated in FIGS. 7 and 9-14.

According to an aspect, when transitioning from the natural input experience mode to the desktop experience mode, the application UI experience mode module 114 reconfigures the application UI 110 to a more traditional operational mode, such as involving user interaction via precision input devices, such as a mouse, trackpad, hardware keyboard, etc. In some examples, when reconfiguring an application UI 110 from the natural input experience mode to the desktop experience mode, the application UI experience mode module 114 changes the behavior of functionality controls to utilize features specific to a mouse or other type of pointing device. In other examples, the application UI experience mode module 114 enables particular application UI interaction functionalities (e.g., hovering). In other examples, the application 108 adds application window commands, such as minimize, maximize, close, and restore commands to a title bar of the application UI 110. Various examples of desktop experience mode UI configurations are illustrated in FIGS. 5,6, and 15-17.

FIG. 2B is a high level flowchart showing general stages involved in another example method for transitioning an application user interface 110 to a particular experience mode configuration based on a detection of an experience mode transition triggering event via the operating system 104. In the example method 208 illustrated in FIG. 2B, user input is required before transitioning the experience mode configuration of the application UI 110.

The method 208 begins when an event that indicates a change in the operating system 104 experience mode occurs. For instance, the mode transition event represents a change from the desktop experience mode to the natural input experience mode, or vice-versa. At OPERATION 210, the mode transition event is detected as described above with respect to FIG. 2A.

The method 208 proceeds to OPERATION 212, where a notification is provided to the user 116 by the operating system 104 in response to the mode transition event. According to an aspect, the notification prompts the user 116 to select whether to transition from the desktop experience mode to the natural input experience mode or from the natural input experience mode to the desktop experience mode, depending on the current mode and the action triggering the mode transition event.

At DECISION OPERATION 214, a determination is made as to whether the user 116 selects to change the experience mode, selects to not change the experience mode, or to dismiss the event. If an indication of a negative response from the user is received, for example, a selection made by the user to not change the current experience mode or to dismiss the notification, the experience mode does not transition, and the method 208 ends.

If an indication of a selection to change the experience mode is received, the method 208 proceeds to OPERATION 215, where the experience mode is changed, and the OS experience mode module 106 reconfigures the OS user interface 120, for example, from the desktop experience mode configuration to the natural input experience mode configuration or from the natural input experience mode configuration to the desktop experience mode configuration. The method 208 then proceeds to OPERATION 216, where the operating system 104 notifies the application UI experience mode module 114 via the OS experience mode module 106 to transition the experience mode. For example, if the application 108 is in the desktop experience mode, the operating system 104 notifies the application UI experience mode module 114 to transition to the natural input experience mode. As another example, if the application 108 is in the natural input experience mode, the operating system 104 notifies the application UI experience mode module 114 to transition to the desktop experience mode.

The method 208 advances to OPERATION 218, where the application UI experience mode module 114 reconfigures the application UI 110 based on the experience mode, for example, from the desktop experience mode to the natural input experience mode, or from the natural input experience mode to the desktop experience mode.

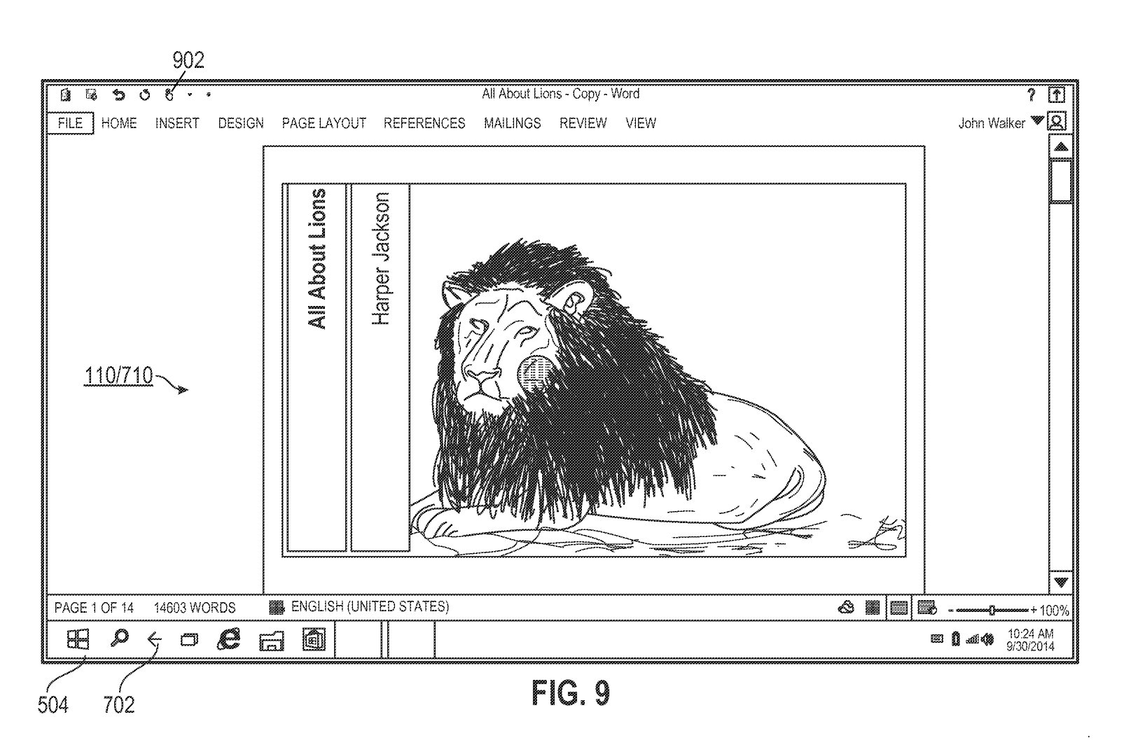

FIG. 2C is a high level flowchart showing general stages involved in an example method for transitioning an application user interface 110 to a particular experience mode configuration in response to an experience mode transition triggering event signaled by the application 108. The method 220 begins when an event associated with an experience mode change occurs in the application 108. In some examples, the event associated with an experience mode change is a manual selection by the user 116, for example, a selection of an experience mode functionality control displayed in the application UI 110. An example of the experience mode functionality control 902 is illustrated in FIGS. 9-18. In some examples, a manual selection of an experience mode in the application 108 is like a manual override of the application experience mode.

The method 220 continues to OPERATION 222, where the application experience mode module 114 detects the event, and at OPERATION 224, changes the experience mode of the application 108 to the selected experience mode, and reconfigures the application UI 110 based on the experience mode. For example, if the application 108 was in the desktop experience mode and the user 116 selects the experience mode functionality control 902 to change the experience mode to the natural input experience mode, the application 108 reconfigures the application UI 110 to the natural input mode UI configuration optimized for natural interaction input, such as touch input, gesture input, air gestures input, head and eye tracking input, etc.

The method 220 proceeds to OPERATION 226, where an operating system-initiated mode transition event occurs, the operating system experience mode module 106 reconfigures the operating system UI 120 based on the experience mode, and signals the application experience mode module 114 of the experience mode transition event. In one example, the operating system experience mode module 106 broadcasts the mode transition event via the OS experience mode module API, and the application experience mode module API listens for and receives indication of the OS mode transition event. In another example, the application experience mode module API makes a call to the OS experience mode module API for an OS mode transition event.

The method 220 continues to OPERATION 228, where the application experience mode module 114 does not change the current manually-selected experience mode, and the application UI 110 remains in the current manually-selected experience mode configuration regardless of the OS experience mode transition.

For example, consider that the operating system 104 and the application 108 are in the desktop experience mode, and the user 116 manually selects to put the application 108 into the natural input experience mode. Accordingly, the application 108 transitions to the natural input experience mode, and the application UI 110 is reconfigured to the natural input UI configuration. Next, consider that the user 116 detaches a keyboard or other hardware device from the computer 102. Accordingly, the operating system 104 transitions to the natural input experience mode, and signals the application 108 of the transition. According to an aspect, the application 108 remains in the natural input experience mode. Next, consider that the user 116 reattaches the keyboard or other hardware device to the computer 102. Accordingly, the operating system 104 transitions to the desktop experience mode, and signals the application 108 of the transition. According to an aspect, the application 108 remains in the natural input experience mode.

FIG. 2D is a high level flowchart showing general stages involved in an example method for transitioning to a mode-optimized version of the application 108 in response based on a detection of an experience mode transition triggering event via the operating system 104. The method 230 begins when an event that indicates a change in the operating system 104 experience mode occurs. For instance, the mode transition event represents a change from the desktop experience mode to the natural input experience mode, or vice-versa. At OPERATION 232, the mode transition event is detected. At OPERATION 234, the OS user interface 120 is transitioned from its current experience mode to the experience mode associated with the mode transition event, and the operating system 104 reconfigures the OS user interface 120 based on the experience mode, for example, as described above with respect to FIG. 2A.

The method 230 continues to OPERATION 236, where the currently running application 108 does not have or support the experience mode to which the OS user interface 120 transitioned. Accordingly, the operating system 104 signals a mode-optimized version of the application 108 (e.g., a version of the application 108 that does have or support the experience mode to which the OS user interface 120 transitioned) to execute or launch in the experience mode associated with the mode transition event. The mode-optimized version of the application 108 receives the signal and launches.

The method 230 continues to OPERATION 238, where the mode-optimized version of the application 108 provides the application UI 110 in the experience mode associated with the mode transition event, and restores relevant context of the previously launched application 108. For example, the mode-optimized version of the application 108 makes sure that the right document is opened, and scrolls to the right location, etc., so that it feels seamless to the user 116.

Referring now to FIGS. 3-7, examples illustrating a transition from the desktop experience mode to the natural input experience mode are shown. In FIG. 3, a computing device 102 attached to a keyboard 302 is illustrated. Accordingly and as illustrated, the operating system 104 is in the desktop experience mode. In the illustrated example, the input device is a keyboard 302. This is not intended to be limiting, however, and the input device may be implemented in various other ways, such as a game controller, a music controller, a mouse, a touchpad, etc.

In FIG. 4, a desktop experience mode OS start menu 402 is opened via a mouse or other pointer or keyboard selection. As illustrated, in the desktop experience mode, the desktop experience mode OS start menu 402 is displayed in a compact region of the display 118, and includes various menu selection items that are displayed in a smaller display size and are compactly arranged. Additionally, the status bar (sometimes referred to as a taskbar) 402 does not include a back button, The user 116 then selects a menu selection item via a mouse or other pointer to launch an application 108. According to the illustrated example, the application 108 is a notes application.

In FIG. 5, the application 108 is in the desktop experience mode, and the application UI 110 is displayed as a desktop experience mode UI 510 on the display 118 of the computing device 102. For example, in the desktop experience mode, the application UI 110 includes windows controls 502, such as minimize, maximize, close, and restore commands.

In FIG. 6, the user 116 detaches the computing device 102 from the keyboard 302, which causes a mode transition event 602. Accordingly, in some examples, the operating system 104 displays a notification 604, prompting the user 116 to select to transition from the desktop experience mode to the natural input experience mode. As illustrated, the user 116 selects to transition to the natural input experience mode, and accordingly, the operating system 104 transitions to the natural input experience mode, and signals the application 108 to transition to the natural input experience mode. There can be various terms to describe the natural input experience mode. In some examples, the natural input experience mode may be referred to as a tablet mode. According to an aspect, the term used to describe the natural input experience mode may be determined by the particular type of computing device 102 being used.

In FIG. 7, the application 108 transitions to the natural input experience mode, and reconfigures the application UI 110 to a natural input experience mode UI 710. For example, the application UI 110 becomes immersive and fills the display 118, and functionality controls are optimized for natural interaction input, such as touch input, gesture input, air gestures input, head and eye tracking input, etc., as described above. As illustrated, a back button 702 is added to the OS taskbar 504 by the OS experience mode module 106.

With reference now to FIGS. 8-17, examples illustrating a transition from the natural input experience mode to the desktop experience mode are shown. In FIG. 8, the operating system 104 is in the natural input experience mode, and a natural input experience mode start menu 802 is displayed in the operating system user interface 120. In the natural input experience mode, the natural input experience mode start menu 802 is displayed as an expanded immersive menu that fills the user interface 120. As illustrated, the natural input experience OS user interface 120 includes enlarged menu selection items with expanded hit target areas in the natural input experience mode start menu 802, and provides a back button 702 in the status bar or taskbar 504, etc. In the illustrated example, the user 116 selects a command to launch the natural input experience mode start menu 802. The user 116 then touches a control 804 to launch an application 108. According to the illustrated example, the application 108 is a word processing application.

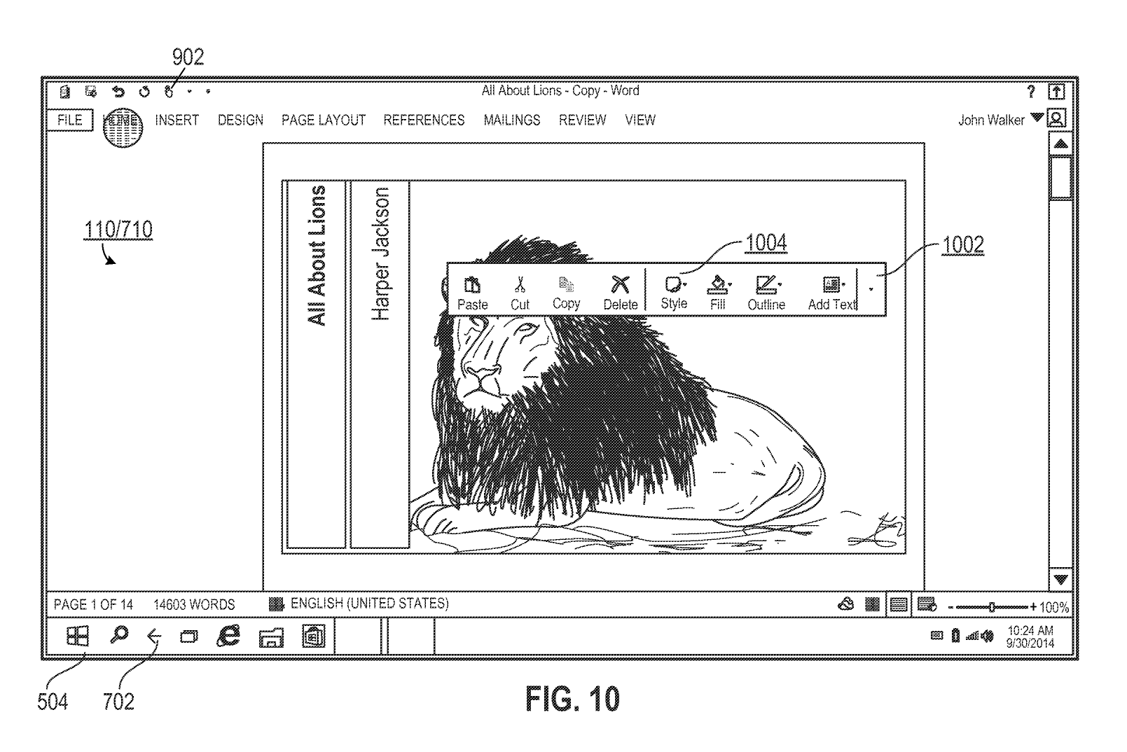

In FIG. 9, the application 108 is in the natural input experience mode, and the application UI 110 is displayed as a natural input experience mode UI 710 on the display 118 of the computing device 102. For example, the application UI 110 is immersive or maximized in the display 118 and fills the display 118, and functionality controls are enlarged and spaced out in the application UI 110, such that it is optimized for natural interaction input, such as touch input, gesture input, air gestures input, head and eye tracking input, etc. The application UI 110 includes an experience mode functionality control 902, which when selected, overrides the application experience mode to the selected experience mode. In some examples and as illustrated in FIG. 10, the application UI 110 in the natural input experience mode includes a natural input floating contextual UI menu 1002 that is displayed instead of mouse-style contextual menu. For example, functionality controls 1004 in the natural input floating contextual UI menu 1002 have larger hit targets. To accommodate larger hit targets in a natural input experience mode, the functionality controls are larger and are spaced farther apart.

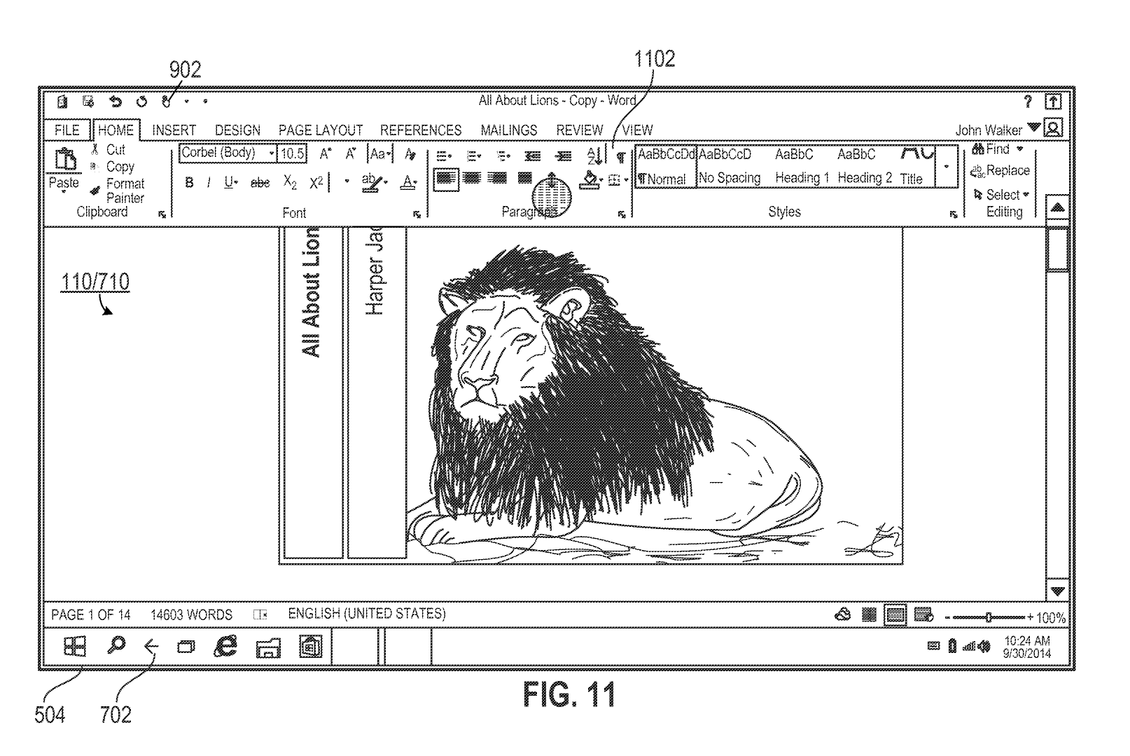

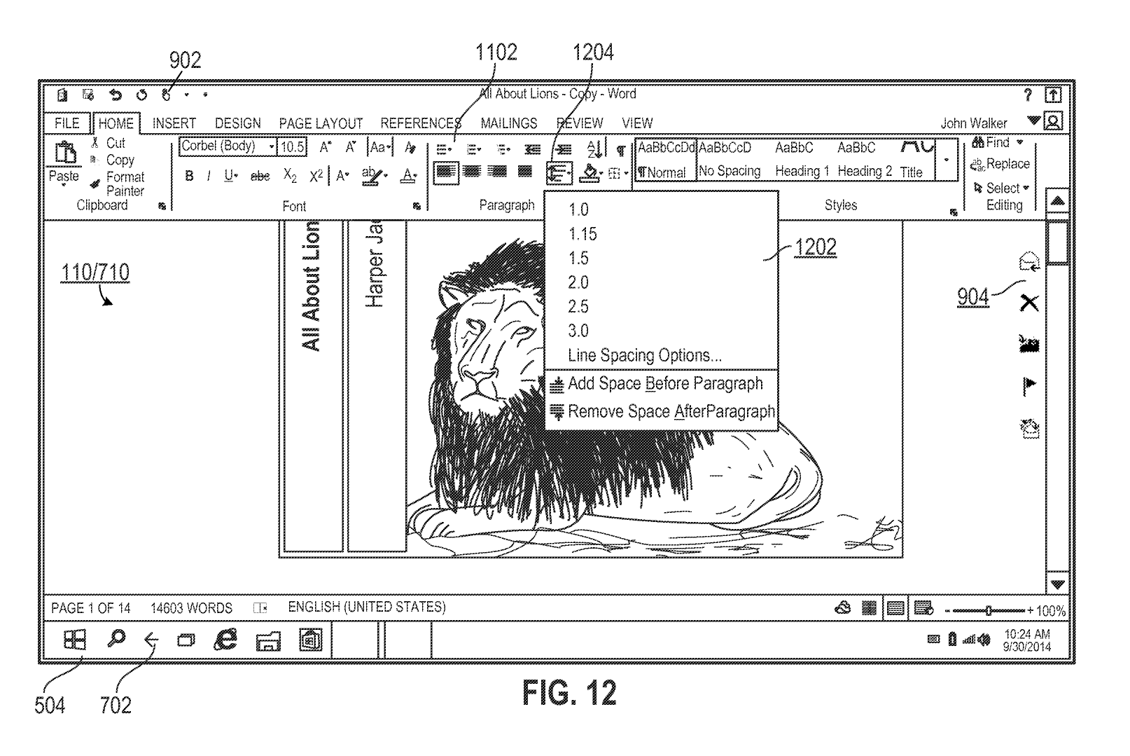

As illustrated in FIG. 11, when the application 108 is in the natural input experience mode, functionality controls in the natural input experience application UI menu 1102 are spaced farther apart, which enables easier selection for natural input methods. As illustrated in FIG. 12, the natural input experience mode UI 710 includes functionalities such as callouts and dropdown menus 1202 from the natural input experience application UI menu 1102. According to an aspect, certain behaviors of functionality controls are changed when in the natural input experience mode. For example, in a desktop experience mode, some functionality controls that have more than one activation region, where one of the activation regions affords access to a superset of functionalities or values associated with the control, such as a split button control 1204 or a spinner control. When such functionality controls are displayed in a natural input experience mode UI, the multiple activation regions are combined into a single target. For example and as illustrated in FIG. 12, selection of any part of the split button control 1204 causes a display of a secondary UI menu (e.g., a dropdown menu 1202, flyout menu, etc.) that includes a list of mutually exclusive values.

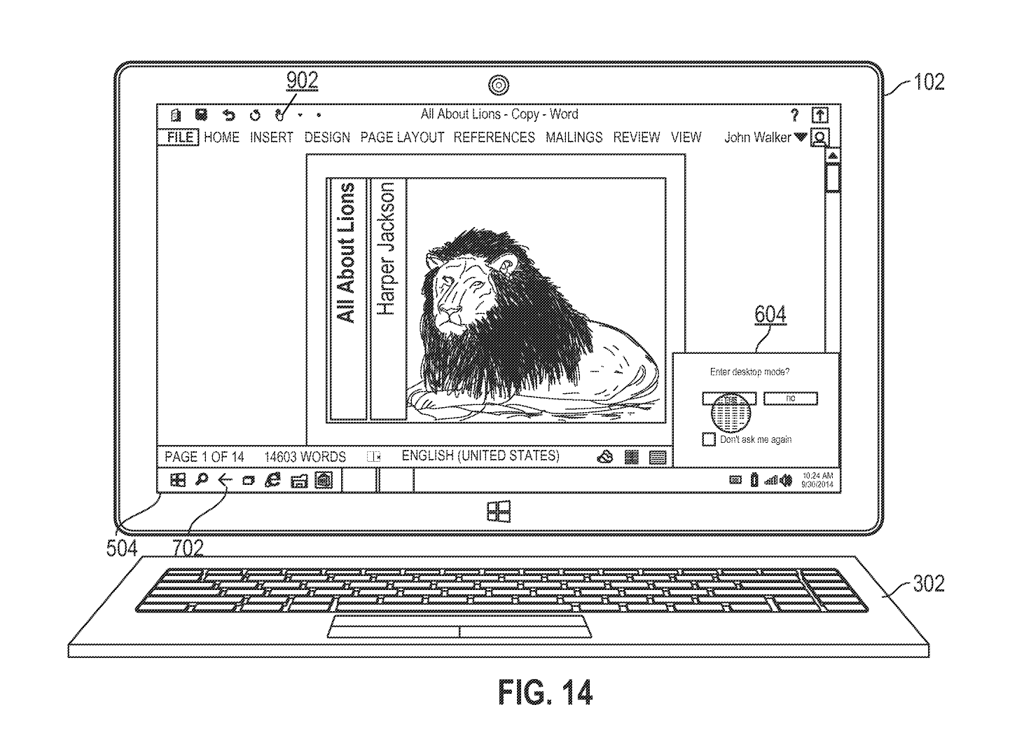

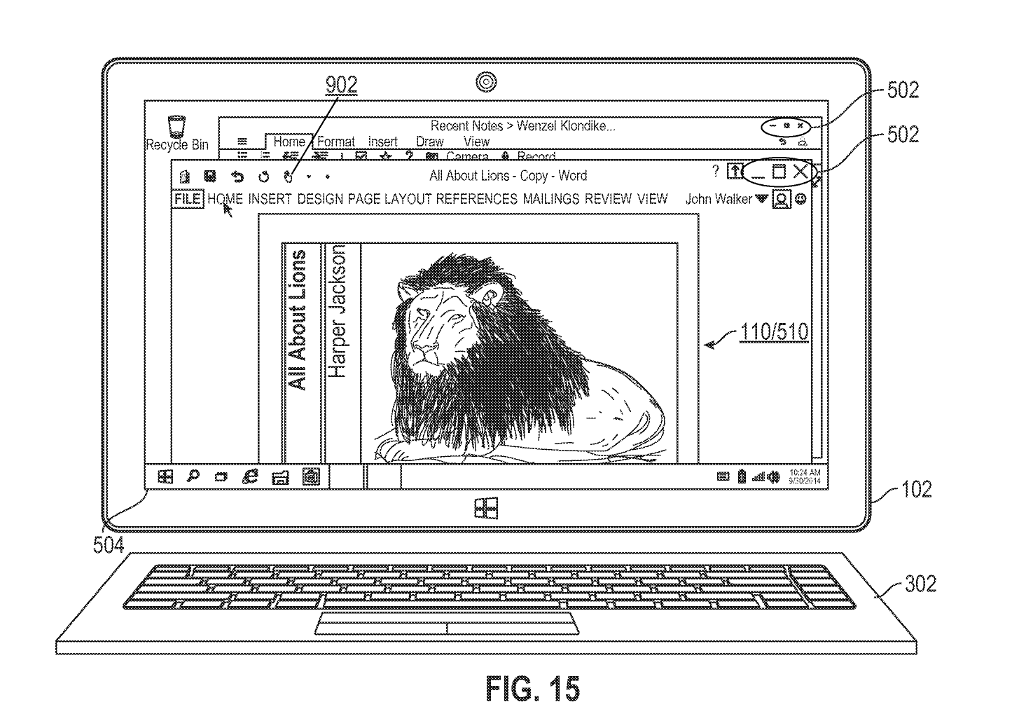

As illustrated in FIG. 13, the user 116 attaches the computing device 102 to the keyboard 302, which causes an OS mode transition event 602. Accordingly, as illustrated in FIG. 14, the operating system 104 provides a notification 604, prompting the user 116 to select whether to transition from the natural input experience mode to the desktop experience mode. As illustrated, the user 116 selects to exit from the current mode and transition to the desktop experience mode. Accordingly, the OS experience mode module 106 transitions the operating system UI 120 to the desktop experience mode, and provides an indication of the transition to the application 108, for example, via the application experience mode module 114. In FIG. 15, the application 108 transitions to the desktop experience mode, and the application UI 110 is reconfigured to the desktop experience mode UI configuration 510. As illustrated, the back button 702 is removed from the OS taskbar 504, applications 108 are re-windowed, and the application UIs 110 are displayed in the desktop experience mode configuration, for example, where the window controls 502 are included in the application UI 110, the touch action bar 904 is removed from display, and functionality controls are displayed larger and farther apart and behavior of the functionality controls are transitioned for precision input.

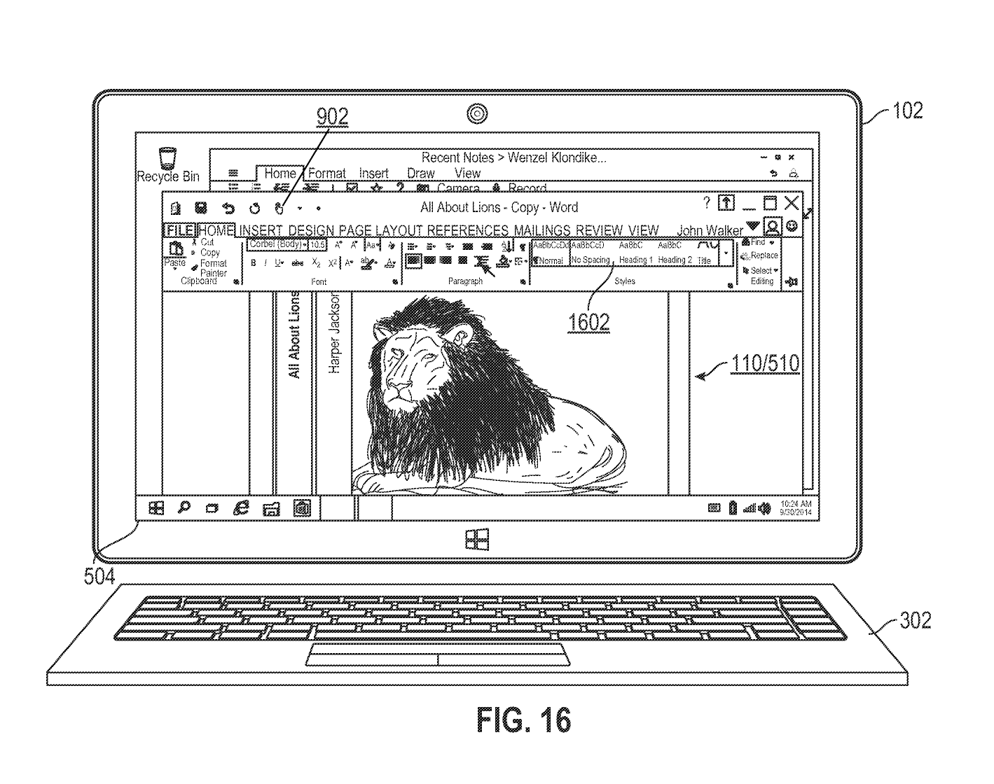

In FIG. 16, a desktop experience application UI menu 1602 is displayed in the desktop experience mode UI 510, where functionality controls in the desktop experience application UI menu 1602 are smaller and are spaced closer together, thus allowing for more functionality controls to be displayed.

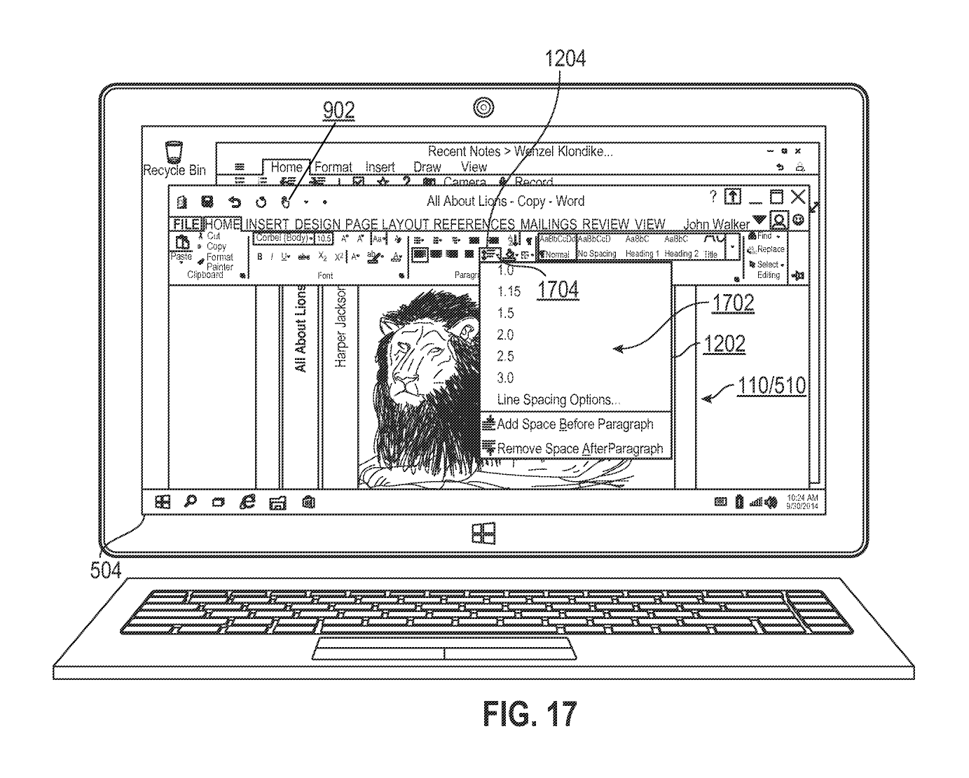

As illustrated in FIG. 17, the desktop experience mode UI 510 includes a tighter layout of desktop experience mode dropdown functionalities 1702. Additionally, certain behaviors of some functionality controls are changed when in the desktop experience mode, for example, split button controls 1204, spinner controls, and other functionality controls that have multiple activation regions. For example, in the desktop experience mode, a user may be required to select a dropdown arrow portion 1704 of a split button control 1204 to cause a display of a secondary UI menu (e.g., a dropdown menu 1202, flyout menu, etc.). This behavior differs from the behavior of a split button control 1204 in a natural input experience mode, where a secondary UI menu is launched via a selection of any portion of the split button control.

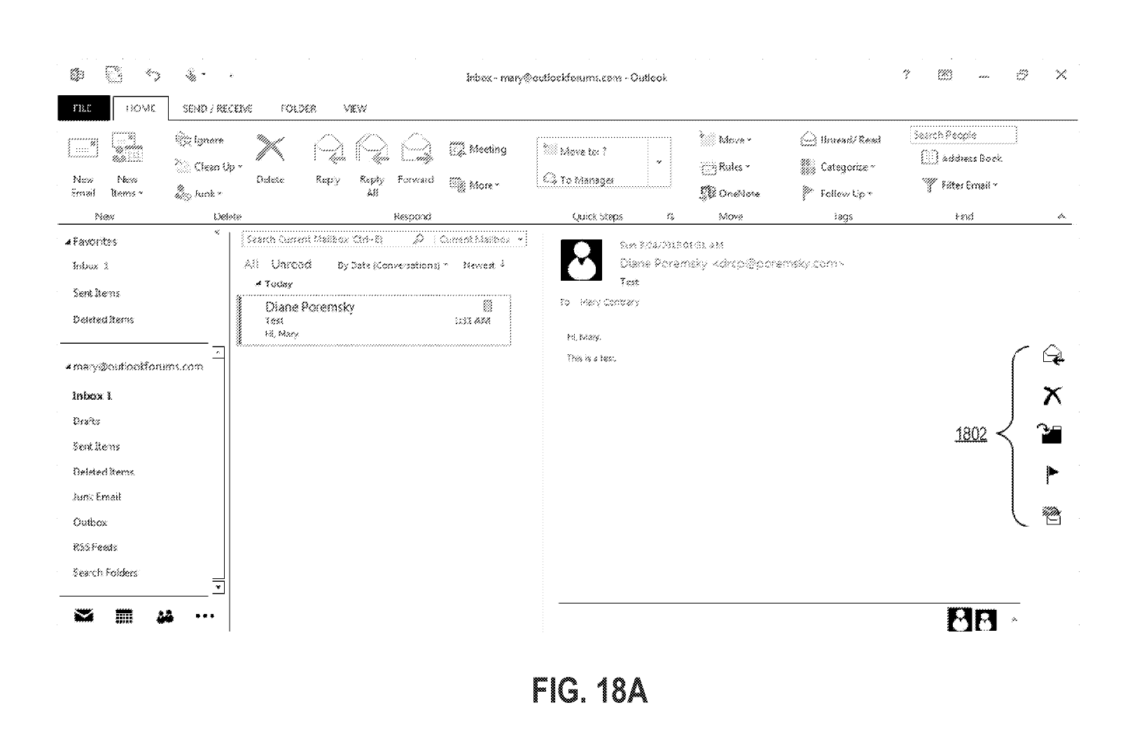

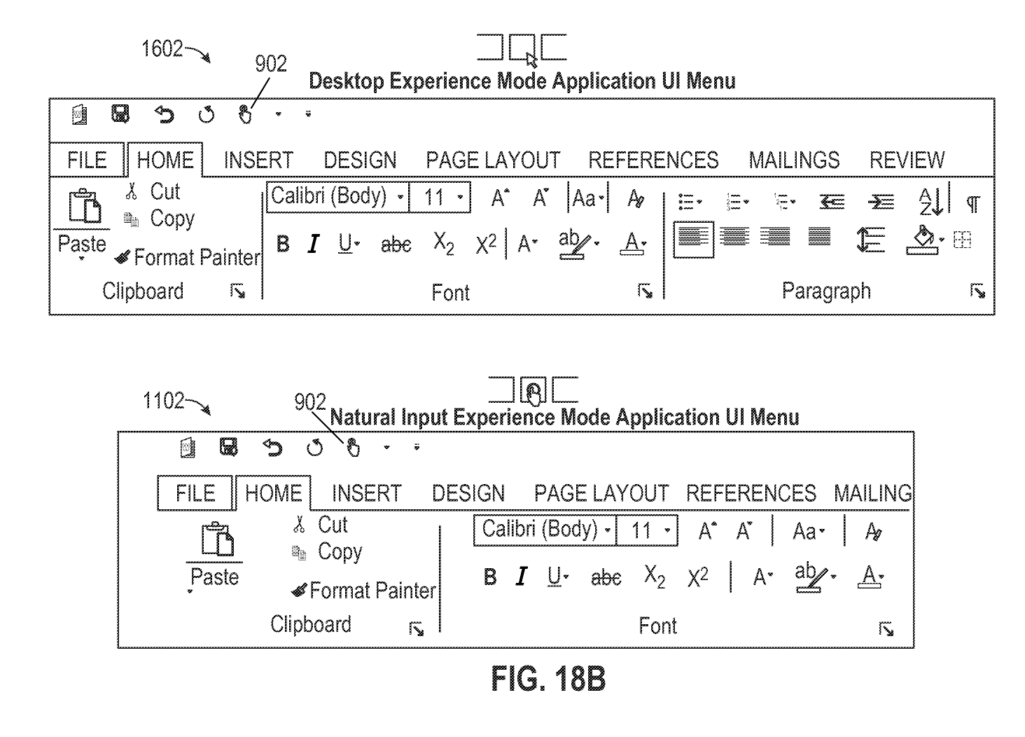

FIG. 18A is an illustration of an example application UI 110 when the application 108 (in this example, an email application) is in the natural input experience mode. In some examples and as illustrated, a touch action bar 1802 is included in the application UI 110 when the application 108 is in the natural input experience mode. According to an example, the touch action bar 1802 is pinned to a right edge of the application UI 110 and includes a plurality of functionality controls. For example, in a mail application, the touch action bar 1802 may include such functionality controls as a reply, reply to all, or forward command, a delete command, a move or copy to folder command, a flag for follow up command, and a mark as read or unread command.

FIG. 18B shows a comparison of an example desktop experience mode application UI menu 1602 and an example natural input experience mode application UI menu 1102. As can be seen, the functionality controls in the natural input experience mode application UI menu 1102 are spaced farther apart and include additional padding, thus providing an optimized experience for natural interaction input, such as touch input, gesture input, air gestures input, head and eye tracking input, etc. Since functionality controls are smaller and are spaced closer together in the desktop experience mode, more functionality controls can be displayed in the desktop experience mode application UI menu 1602.

Examples of a user interface transitioning system and method provide for: receiving an indication of an operating system experience mode transition event in response to a change from a first experience mode to a second experience mode by the operating system; transitioning the experience mode of the application 108 to the second experience mode; and generating a display of the application user interface in the second experience mode configuration 710, wherein the application user interface is reconfigured from the first experience mode configuration 510 to include a change in at least one of: sizing of application user interface functionality controls 1004; spacing between application user interface functionality controls; hit target areas of application user interface functionality controls; and behavior of functionality controls with multiple activation regions.

While examples have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which examples are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

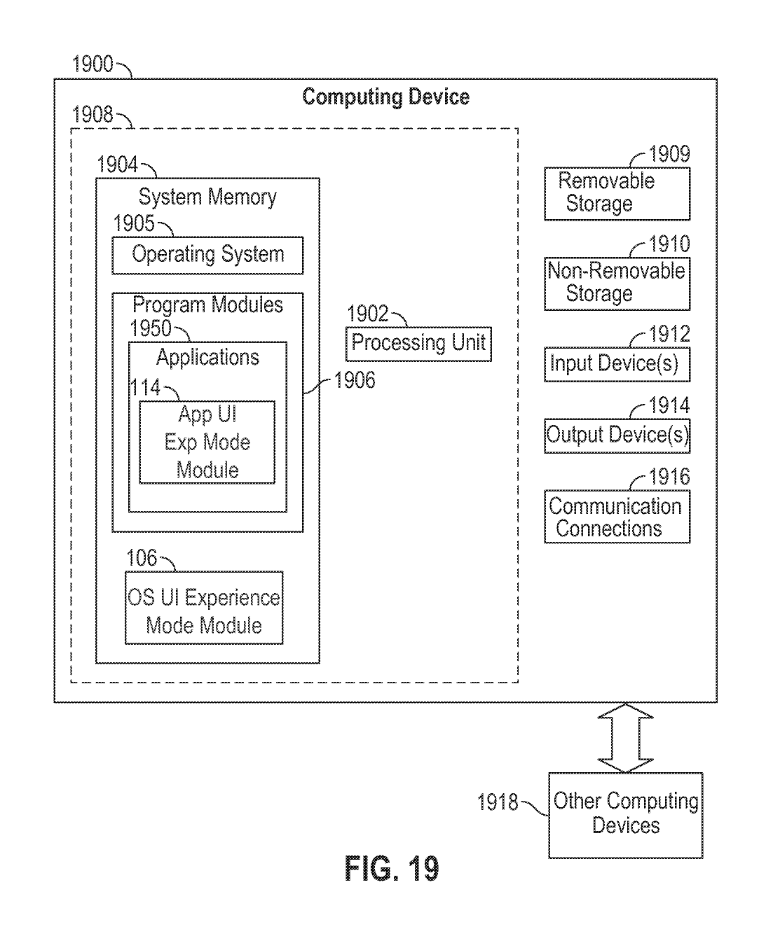

FIG. 19-21 and the associated descriptions provide a discussion of a variety of operating environments in which examples are practiced. However, the devices and systems illustrated and discussed with respect to FIGS. 19-21 are for purposes of example and illustration and are not limiting of a vast number of computing device configurations that are utilized for practicing examples, described herein.

FIG. 19 is a block diagram illustrating physical components (i.e., hardware) of a computing device 1900 with which examples of the present disclosure are be practiced. In a basic configuration, the computing device 1900 includes at least one processing unit 1902 and a system memory 1904. According to an aspect, depending on the configuration and type of computing device, the system memory 1904 comprises, but is not limited to, volatile storage (e.g., random access memory), non-volatile storage (e.g., read-only memory), flash memory, or any combination of such memories. According to an aspect, the system memory 1904 includes an operating system 1905 and one or more programming modules 1906 suitable for running software applications 1950. According to an aspect, the system memory 1904 includes the experience mode module 106 and the application UI experience mode module 114. The operating system 1905, for example, is suitable for controlling the operation of the computing device 1900. Furthermore, examples are practiced in conjunction with a graphics library, other operating systems, or any other application program, and is not limited to any particular application or system. This basic configuration is illustrated in FIG. 19 by those components within a dashed line 1908. According to an aspect, the computing device 1900 has additional features or functionality. For example, according to an aspect, the computing device 1900 includes additional data storage devices (removable and/or non-removable) such as, for example, magnetic disks, optical disks, or tape. Such additional storage is illustrated in FIG. 19 by a removable storage device 1909 and a non-removable storage device 1910.

As stated above, according to an aspect, a number of program modules and data files are stored in the system memory 1904. While executing on the processing unit 1902, the program modules 1906 (e.g., experience mode module 106) performs processes including, but not limited to, one or more of the stages of the method 200 illustrated in FIG. 2. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, examples are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 19 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 1900 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, examples are practiced within a general purpose computer or in any other circuits or systems.

According to an aspect, the computing device 1900 has one or more input device(s) 1912 such as a keyboard, a mouse, a pen, a sound input device, a touch input device, etc. The output device(s) 1914 such as a display, speakers, a printer, etc. are also included according to an aspect. The aforementioned devices are examples and others may be used. According to an aspect, the computing device 1900 includes one or more communication connections 1916 allowing communications with other computing devices 1918. Examples of suitable communication connections 1916 include, but are not limited to, RF transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 1904, the removable storage device 1909, and the non-removable storage device 1910 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1900. According to an aspect, any such computer storage media is part of the computing device 1900. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

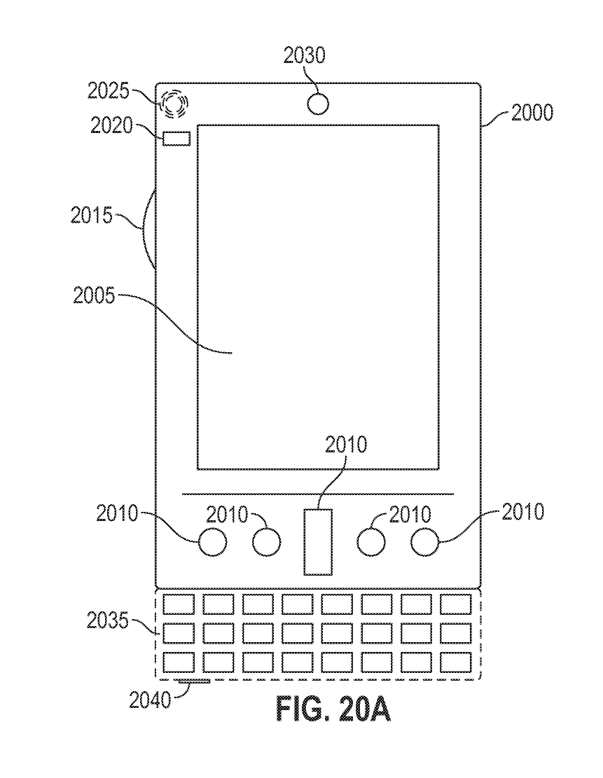

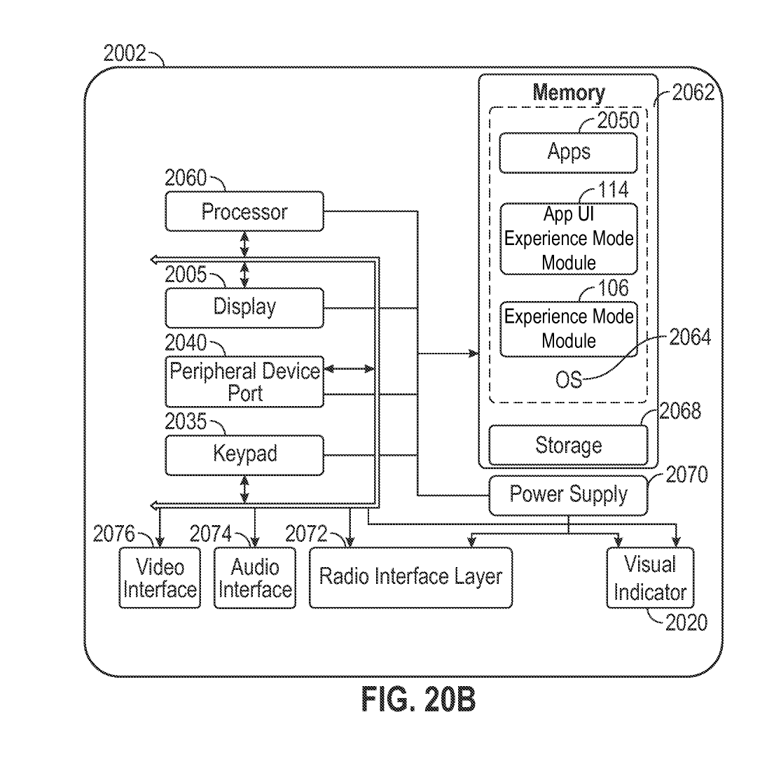

FIGS. 20A and 20B illustrate a mobile computing device 2000, for example, a mobile telephone, a smart phone, a tablet personal computer, a laptop computer, and the like, with which examples may be practiced. With reference to FIG. 20A, an example of a mobile computing device 2000 for implementing the aspects is illustrated. In a basic configuration, the mobile computing device 2000 is a handheld computer having both input elements and output elements. The mobile computing device 2000 typically includes a display 2005 and one or more input buttons 2010 that allow the user to enter information into the mobile computing device 2000. According to an aspect, the display 2005 of the mobile computing device 2000 functions as an input device (e.g., a touch screen display). If included, an optional side input element 2015 allows further user input. According to an aspect, the side input element 2015 is a rotary switch, a button, or any other type of manual input element. In alternative examples, mobile computing device 2000 incorporates more or less input elements. For example, the display 2005 may not be a touch screen in some examples. In alternative examples, the mobile computing device 2000 is a portable phone system, such as a cellular phone. According to an aspect, the mobile computing device 2000 includes an optional keypad 2035. According to an aspect, the optional keypad 2035 is a physical keypad. According to another aspect, the optional keypad 2035 is a “soft” keypad generated on the touch screen display. In various aspects, the output elements include the display 2005 for showing a graphical user interface (GUI), a visual indicator 2020 (e.g., a light emitting diode), and/or an audio transducer 2025 (e.g., a speaker). In some examples, the mobile computing device 2000 incorporates a vibration transducer for providing the user with tactile feedback. In yet another example, the mobile computing device 2000 incorporates input and/or output ports, such as an audio input (e.g., a microphone jack), an audio output (e.g., a headphone jack), and a video output (e.g., a HDMI port) for sending signals to or receiving signals from an external device.

FIG. 20B is a block diagram illustrating the architecture of one example of a mobile computing device. That is, the mobile computing device 2000 incorporates a system (i.e., an architecture) 2002 to implement some examples. In one example, the system 2002 is implemented as a “smart phone” capable of running one or more applications (e.g., browser, e-mail, calendaring, contact managers, messaging clients, games, and media clients/players). In some examples, the system 2002 is integrated as a computing device, such as an integrated personal digital assistant (PDA) and wireless phone.

According to an aspect, one or more application programs 2050 are loaded into the memory 2062 and run on or in association with the operating system 2064. Examples of the application programs include phone dialer programs, e-mail programs, personal information management (PIM) programs, word processing programs, spreadsheet programs, Internet browser programs, messaging programs, and so forth. According to an aspect, the experience mode module 106 and the application UI experience mode module 114 are loaded into memory 2062. The system 2002 also includes a non-volatile storage area 2068 within the memory 2062. The non-volatile storage area 2068 is used to store persistent information that should not be lost if the system 2002 is powered down. The application programs 2050 may use and store information in the non-volatile storage area 2068, such as e-mail or other messages used by an e-mail application, and the like. A synchronization application (not shown) also resides on the system 2002 and is programmed to interact with a corresponding synchronization application resident on a host computer to keep the information stored in the non-volatile storage area 2068 synchronized with corresponding information stored at the host computer. As should be appreciated, other applications may be loaded into the memory 2062 and run on the mobile computing device 2000.

According to an aspect, the system 2002 has a power supply 2070, which is implemented as one or more batteries. According to an aspect, the power supply 2070 further includes an external power source, such as an AC adapter or a powered docking cradle that supplements or recharges the batteries.

According to an aspect, the system 2002 includes a radio 2072 that performs the function of transmitting and receiving radio frequency communications. The radio 2072 facilitates wireless connectivity between the system 2002 and the “outside world,” via a communications carrier or service provider. Transmissions to and from the radio 2072 are conducted under control of the operating system 2064. In other words, communications received by the radio 2072 may be disseminated to the application programs 2050 via the operating system 2064, and vice versa.

According to an aspect, the visual indicator 2020 is used to provide visual notifications and/or an audio interface 2074 is used for producing audible notifications via the audio transducer 2025. In the illustrated example, the visual indicator 2020 is a light emitting diode (LED) and the audio transducer 2025 is a speaker. These devices may be directly coupled to the power supply 2070 so that when activated, they remain on for a duration dictated by the notification mechanism even though the processor 2060 and other components might shut down for conserving battery power. The LED may be programmed to remain on indefinitely until the user takes action to indicate the powered-on status of the device. The audio interface 2074 is used to provide audible signals to and receive audible signals from the user. For example, in addition to being coupled to the audio transducer 2025, the audio interface 2074 may also be coupled to a microphone to receive audible input, such as to facilitate a telephone conversation. According to an aspect, the system 2002 further includes a video interface 2076 that enables an operation of an on-board camera 2030 to record still images, video stream, and the like.

According to an aspect, a mobile computing device 2000 implementing the system 2002 has additional features or functionality. For example, the mobile computing device 2000 includes additional data storage devices (removable and/or non-removable) such as, magnetic disks, optical disks, or tape. Such additional storage is illustrated in FIG. 20B by the non-volatile storage area 2068.

According to an aspect, data/information generated or captured by the mobile computing device 2000 and stored via the system 2002 is stored locally on the mobile computing device 2000, as described above. According to another aspect, the data is stored on any number of storage media that is accessible by the device via the radio 2072 or via a wired connection between the mobile computing device 2000 and a separate computing device associated with the mobile computing device 2000, for example, a server computer in a distributed computing network, such as the Internet. As should be appreciated such data/information is accessible via the mobile computing device 2000 via the radio 2072 or via a distributed computing network. Similarly, according to an aspect, such data/information is readily transferred between computing devices for storage and use according to well-known data/information transfer and storage means, including electronic mail and collaborative data/information sharing systems. In yet another example, the mobile computing device 2000 incorporates peripheral device port 2040, such as an audio input (e.g., a microphone jack), an audio output (e.g., a headphone jack), and a video output (e.g., a HDMI port) for sending signals to or receiving signals from an external device.

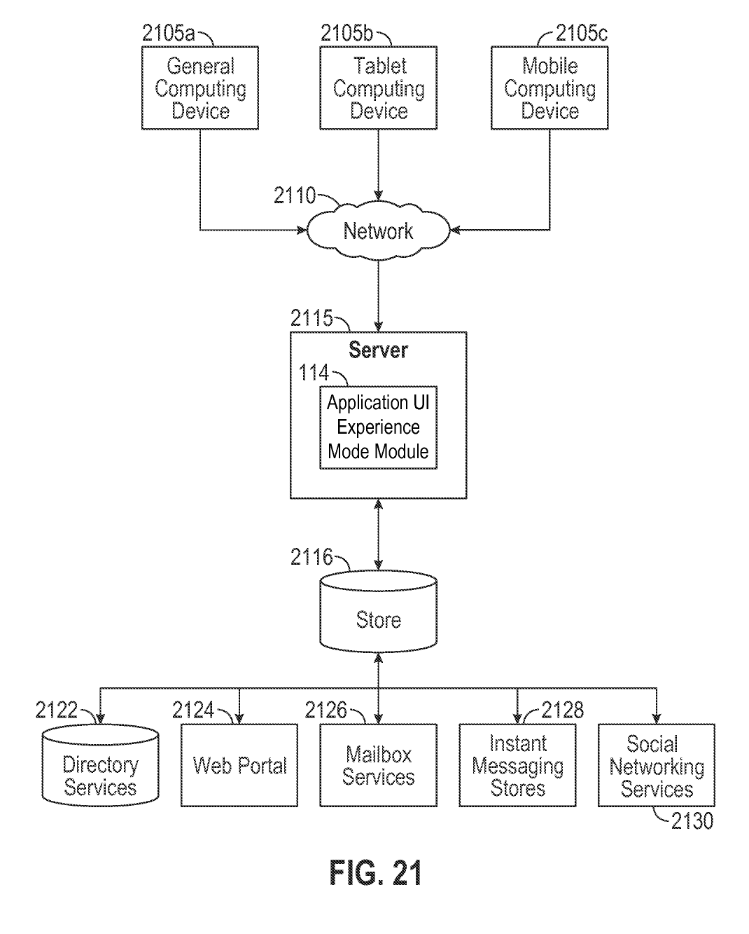

FIG. 21 illustrates one example of the architecture of a system for transitioning an application user interface 110 to a particular experience mode configuration as described above. Content developed, interacted with, or edited in association with the experience mode module 106 and the application UI experience mode module 114 is enabled to be stored in different communication channels or other storage types. For example, various documents may be stored using a directory service 2122, a web portal 2124, a mailbox service 2126, an instant messaging store 2128, or a social networking site 2130. The application UI experience mode module 114 is operable to use any of these types of systems or the like for transitioning an application user interface 110 to a particular experience mode configuration, as described herein. According to an aspect, a server 2115 provides the application UI experience mode module 114 to client computing device 2105a,b,c. As one example, the server 2115 is a web server providing the application UI experience mode module 114 over the web. The server 2115 provides the application UI experience mode module 114 over the web to clients 2105 through a network 2110. By way of example, the client computing device is implemented and embodied in a personal computer 2105a, a tablet computing device 2105b or a mobile computing device 2105c (e.g., a smart phone), or other computing device. Any of these examples of the client computing device are operable to obtain content from the store 2116.

Examples are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope of the claims in any way. The aspects, examples, and details provided in this application are considered sufficient to convey possession and enable others to make and use the best mode. Examples should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

What is claimed is:

1. A method for transitioning a user interface of an application from a first experience mode configuration to a second experience mode configuration for display on a computing device, the method comprising:
receiving an indication of an experience mode transition event associated with a transition of an experience mode of an operating system of the computing device from a first experience mode to a second experience mode;
changing the experience mode of the application from the first experience mode to the second experience mode; and
changing a display of the user interface of the application from the first experience mode configuration to the second experience mode configuration.

2. The method of claim 1, wherein:
changing the experience mode of the application from the first experience mode to the second experience mode comprises changing the experience mode of the application from a desktop experience mode to a natural input experience mode; and
changing a display of the user interface of the application from the first experience mode configuration to the second experience mode configuration comprises changing the display of the user interface of the application from a desktop experience mode configuration to a natural input experience mode configuration.

3. The method of claim 2, wherein receiving an indication of an experience mode transition event associated with a transition of an experience mode of an operating system of the computing device from the desktop experience mode to the natural input experience mode comprises receiving an indication of an experience mode transition event associated with one of:
a physical disconnection of a hardware input device;
a wireless disconnection of a hardware input device; and
user input instructing a change from the desktop experience mode to the natural input experience mode.

4. The method of claim 2, wherein changing the experience mode of the application from the desktop experience mode to the natural input experience mode comprises:
launching a second application, the second application comprising the natural input experience mode;
generating a display of a user interface of the second application in the natural input experience mode configuration; and
restoring a relevant context of the application.

5. The method of claim 4, wherein restoring the relevant context of the application comprises opening a document in the second application, wherein the document is a document opened in the application when the indication of the experience mode transition event was received.

6. The method of claim 5, wherein restoring the relevant context of the application comprises scrolling to a location in the document, wherein the location in the document is a location of where the document was scrolled to in the application when the indication of the experience mode transition event was received.

7. The method of claim 1, wherein:
changing the experience mode of the application from the first experience mode to the second experience mode comprises changing the experience mode of the application from a natural input experience mode to a desktop input experience mode; and
changing a display of the user interface of the application from the first experience mode configuration to the second experience mode configuration comprises changing the display of the user interface of the application from a natural input experience mode configuration to a desktop experience mode configuration.

8. The method of claim 7, wherein receiving an indication of an experience mode transition event associated with a transition of an experience mode of an operating system of the computing device from the natural input experience mode to the desktop experience mode comprises receiving an indication of an experience mode transition event associated with one of:
a physical connection of a hardware input device;
a wireless connection of a hardware input device; and
user input instructing a change from the natural input experience mode to the desktop experience mode.

9. The method of claim 1, wherein prior to receiving an indication of an experience mode transition event associated with a transition of an experience mode of an operating system of the computing device from a first experience mode to a second experience mode, receiving permission from a user to change the experience mode of the operating system.

10. The method of claim 1, further comprising:
receiving an indication of an experience mode transition event associated with a manual selection to transition the experience mode of the application from the second experience mode to the first experience mode;
changing the experience mode of the application from the second experience mode to the first experience mode; and
changing the display of the user interface of the application from the second mode configuration to the first experience mode configuration.

11. The method of claim 10, further comprising:
receiving an indication of an experience mode transition event associated with a transition of the experience mode of the operating system of the computing device from the second experience mode to the first experience mode;
maintaining the first experience mode of the application;
receiving an indication of an experience mode transition event associated with a transition of the experience mode of the operating system of the computing device from the first experience mode to the second experience mode; and
maintaining the first experience mode of the application.

12. A system for transitioning a user interface of an application from a first experience mode configuration to a second experience mode configuration for display on a computing device, the system comprising:
a processor;
a memory,
an operating system experience mode module associated with an operating system of the computing device, the operating system experience mode module operable to:
receive an indication of an experience mode transition event associated with a transitioning an experience mode of the operating system from a first experience mode to a second experience mode;
transition the experience mode of the operating system from the first experience mode to the second experience mode;
change a display of the user interface of the operating system from the first experience mode configuration to the second experience mode configuration; and
provide a notification of the experience mode transition event associated with the transition of the experience mode of the operating system from the first experience mode to the second experience mode; and
an application experience mode module, the application experience mode module operable to:
receive the notification of an experience mode transition event associated with the transition of the experience mode of the operating system from the first experience mode to the second experience mode;
change the experience mode of the application from the first experience mode to the second experience mode; and
change a display of the user interface of the application from the first experience mode configuration to the second experience mode configuration.

13. The system of claim 12, wherein:
the first experience mode is a desktop experience mode;
the second experience mode is a natural input experience mode;
the first experience mode configuration is a desktop experience mode configuration;
the second experience mode configuration is a natural input experience mode configuration; and
in receiving an indication of an experience mode transition event associated with a transitioning an experience mode of the operating system from a first experience mode to a second experience mode, the operating system experience mode module is operable to:
receive an indication of an experience mode transition event associated with one of:
a physical disconnection of a hardware input device;
a wireless disconnection of a hardware input device; and
user input instructing a change from the desktop experience mode to the natural input experience mode.

14. The system of claim 13, wherein in changing the experience mode of the application from the first experience mode to the second experience mode, the application experience mode module is operable to:
launch a second application, the second application comprising the natural input experience mode;
generate a display of a user interface of the second application in the natural input experience mode configuration; and
restore a relevant context of the application.

15. The system of claim 14, wherein in restoring the relevant context of the application, the application experience mode module is operable to open a document in the second application, wherein the document is a document opened in the application when the indication of the experience mode transition event was received.

16. The system of claim 15, wherein in restoring the relevant context of the application, the application experience mode module is operable to scroll to a location in the document, wherein the location in the document is a location of where the document was scrolled to in the application when the indication of the experience mode transition event was received.

17. The system of claim 12, wherein:
the first experience mode is a natural input experience mode;
the second experience mode is a desktop experience mode;
the first experience mode configuration is a natural input experience mode configuration;
the second experience mode configuration is a desktop experience mode configuration; and
in receiving an indication of an experience mode transition event associated with a transitioning an experience mode of the operating system from a first experience mode to a second experience mode, the operating system experience mode module is operable to:
receive an indication of an experience mode transition event associated with one of:
a physical connection of a hardware input device;
a wireless connection of a hardware input device; and
user input instructing a change from the natural input experience mode to the desktop experience mode.

18. The system of claim 12, wherein:
the application experience mode module is further operable to:
receive an indication of an experience mode transition event associated with a manual selection to transition the experience mode of the application from the second experience mode to the first experience mode;
change the experience mode of the application from the second experience mode to the first experience mode; and
change the display of the user interface of the application from the second mode configuration to the first experience mode configuration;
receive an indication of an experience mode transition event associated with a transition of the experience mode of the operating system from the second experience mode to the first experience mode;
maintain the first experience mode of the application;
receiving an indication of an experience mode transition event associated with a transition of the experience mode of the operating system from the first experience mode to the second experience mode; and
maintain the first experience mode of the application.

19. A computing device comprising a network connection to connect to a web server providing a web-based application, the computing device operable to display a user interface of an operating system of the computing device and a user interface of the web-based application, the computing device comprising an operating system experience mode module operable to:
receive an indication of an experience mode transition event associated with a transitioning an experience mode of the operating system from a first experience mode to a second experience mode;
transition the experience mode of the operating system from the first experience mode to the second experience mode;
change a display of the user interface of the operating system from the first experience mode configuration to the second experience mode configuration; and
provide a notification of the experience mode transition event associated with the transition of the experience mode of the operating system from the first experience mode to the second experience mode.

20. The computing device of claim 19, wherein in response to the notification of the experience mode transition event associated with the transition of the experience mode of the operating system from the first experience mode to the second experience mode , the computing device is further operable to:
change the experience mode of the application from the first experience mode to the second experience mode; and
change a display of the user interface of the application from the first experience mode configuration to the second experience mode configuration.
